(19) United States
(12) Patent Application Publication
(10) Pub. No.: US 2005/0106281 A1
(43) Pub. Date: May 19, 2005

(54) System for molding corrugated pipe

(76) Inventors: Gary L. Karr, Westerville, OH (US); David L. Cyphert, Canal Winchester, OH (US)

Correspondence Address: Gerald L. Smith;Mueller and Smith, LPA, 7700 Rivers Edge Drive, Columbus, OH, 43235, US

(21) Appl. No.: 10/784,752

(22) Filed: Feb. 23, 2004

Related U.S. Application Data
(63) Continuation-in-part of application No. 10/715,760, filed on Nov. 18, 2003.

(51) Int. Cl. B29C 33/24; B29C 53/30; B29D 23/18

(52) U.S. Cl. 425/325; 425/336; 425/539

(57) ABSTRACT

Carriage assembly mounted molds are paired along a production system axis at a receiving region. Each carriage assembly is configured with an axially inwardly depending threaded connector nut configured to engage a translational screw moving the mold sets in registry about an extrusion die to establish a dynamic forming tunnel. Each mold of a mold set is configured having an internal mold cavity with mold crests spaced apart to define a sequence of vacuum support regions. A sequence of annular insert components are positioned over the vacuum support regions to form mold cavities and to define vacuum cavities.

### CROSS-REFERENCE TO RELATED APPLICATIONS

This application is a continuation-in-part of application for U.S. patent Ser. No. 10/715,760, filed Nov. 18, 2003 by Karr and Cyphert, entitled “Die Apparatus For Forming Corrugated Pipe”.

### STATEMENT REGARDING FEDERALLY SPONSORED RESEARCH

Not applicable.

### BACKGROUND OF THE INVENTION

Large diameter corrugated pipe employed for water runoff control, culverts and the like was introduced to the construction industry as a steel product. It's corrugate shape afforded good resistance against necessarily imposed compressive stresses, however, the undulatory pipe interior has not been one providing an efficient fluid flow characteristic. Over the somewhat recent past, as plastic technologies have advanced, opportunities for forming these structures from high density plastics arose.

The general approach to fabricating plastic corrugated pipe has been to extrude viscous thermoplastic material from a die assembly having an annular exit cross section. This extrudate is formed against the internal, corrugated surface of a continuing sequence of indexed mold sets. As the plastic extrudes through gauge defining extrusion die lip assemblies, it is drawn into the moving and now mated die sets, for instance, by an externally imposed vacuum. These mold sets, when united, define a dynamic forming tunnel moving along the production axis.

The plastics involved in this process, for example, high density polyethylene, are problematic in terms of their workability. In this regard, the material is introduced or cut at homogenization stations at the entrance of the extruding die with primary distributors in a plurality of streams. At this step in the process, the material has a somewhat putty-like consistency. These primary distribution streams discharge under high pressure into homogenization spiraling channels through which they progress in the form of a multiple thread. The depth of these helical channels progressively diminishes in the axial or extrusion direction. It is assumed that the stream progressing under pressure through one spiral divides itself into two partial streams. One of these divisional streams flows axially over a land formed between two spirals and the other follows the course of the spiral channel in a helical direction. Ultimately, the material flow is only in the axial direction and this resultant stream is formed by the superpositioning of the divisional streams. By this arrangement, a desired mechanical homogeneity of the now annular melt stream is achieved.

Control over the polymeric material as it progresses through the die both in terms of temperature maintenance and mass distribution has been problematic and a variety of control approaches have been advanced. One earlier such approach to maintaining product wall thickness or gauge consistency included, for example, the provision of adjustable annular extrusion die lips. Such “tweaking” at the gauge defining extrusion output now is being supplanted by modern computer modeling approaches. Temperature excursions within the extrusion system have resulted in a variety of anomalies in the resultant byproduct. For example, a lack of effective temperature control can result in a warped pipe product sometimes referred to as “banana pipe”.

Effective movement of the necessarily bulksom and heavy mold sets or blocks also has proven to be problematic. In the course of the continuous molding process, each mold set is parted from the moving and now molded pipe at a downstream release location, whereupon it must be returned to the molding commencement region of the die to be closed and abuttably indexed against the next axially forwardly adjacent closed mold set. The thus conjoined closed mold sets are axially driven in tandem at a rate controlled in consonance with the extrusion activity. Any vagaries encountered in this continuous process will result in any of a variety of product defects including pipe wall thickness deviations and corrugation pitch changes sometimes referred to as the “accordion effect”. Pitch variations will be manifested not only as an irregular wall surface, but also as a pipe length alteration. A variety of mold set transporting, parking, joining or closing and indexing schemes have been advanced, perhaps the more popular being a chain driven clamshell-like mold set wherein the molds are supported by pivotal mounts which ride, in turn upon continuous chains. With the arrangement, the mounts and molds are returned in an open orientation above the molding process, whereupon they are turned downwardly into alignment with the process axis and closed for indexing. This mechanically complex technique imposes a limitation on the number of mold sets which can be accommodated by the system. As a consequence, production system flexibility is limited. Mold sets which are tied to a common mold conveyor system such as chain mechanisms also are necessarily involved in relatively awkward release and return maneuvers. This limits the number of mold sets which function to establish the moving forming tunnel length.

Other mold set manipulation approaches have involved rack and pinion based systems wherein a rack component is associated with each mold which performs in conjunction with a gear drive; systems wherein each mold is driven by a discrete electric motor with associated electrical leads or umbilicals; and shuttle-based systems.

Each mold of a mold set is designed to establish a sub-atmospheric pressure effective to draw extruded thermoplastic material against a generally corrugated internal mold surface and to establish a cooling capability at the outward surface of a mold. Such cooling typically is derived by an outboard air flow, particularly in the course of what often is a complex system start-up procedure. Often the mold designs require that vacuum be drawn over diverse distance through relatively elaborate and difficult to access vacuum distribution channels. These configurations lead to production difficulties and product anomalies. Where the cooling air distribution channels are excessively lengthy or air flow is but minimally controlled, undesirable product variations may be encountered.

Originally produced plastic corrugated pipe exhibited an amount of undesirable flexibility. Such flexation attributes led to the implementation of internal liners which are co-extruded with the outer corrugated wall from annular extrusion nozzles located adjacent the outer wall extrusion annulus. As this inner liner or wall engages and attaches to the inwardly depending troughs of the outer wall, it moves axially along a cooling sleeve or mandrel.

### BRIEF SUMMARY OF THE INVENTION

The present invention is addressed to system and apparatus for producing corrugated pipe wherein mold and carriage assemblies are drawn together at a paired mold receiving region and advanced along an extrusion die assembly to develop a highly accurately defined dynamic mold tunnel. This accurate tunnel defining movement is achieved with a translation assembly extending in parallel with the production system axis which engages the carriage assemblies of the mold sets and controls their movement in a stable and accurate tandem relationship. Such accuracy and stability is accomplished by implementing the translation assembly as an elongate, continuous screw with a screw thread pitch. Each carriage assembly mounted mold of a conjoined mold set incorporates a connector assembly configured as a threaded nut half or partial nut fixed to a component of the carriage assembly and exhibiting the same thread pitch as the continuous translational screw. To assure proper entry of each threaded connection assembly onto the translational screw, the succession of abutting molds on the screw defining a forming tunnel exhibit a mold-to-mold abutting or reference distance wherein either that reference distance or the some of reference distances for a sequence of molds is an integer multiple of the common thread pitch of the connector assembly and the screw. With the arrangement, the threads of the connector assemblies are positioned to define an effective, uninterrupted and continuous thread pitch association with the threads of the translational screw.

Entrance of mold pair connector assemblies onto the translational screws is by movement along the system axis and in mutually abutting combination with a next forwardly adjacent reference mold set, the connector assemblies of which have previously engaged the screw.

The carriage assembly supporting each mold is structured having a rail mountable primary carriage to which the translational screw engaging threaded connector assemblies are fixed. This primary carriage also establishes the noted reference distance as the distance between forward and aft or rearward bumpers. In general, the primary carriage is configured for movement in parallel with the production system axis. Mounted upon the primary carriage is a mold supporting secondary carriage which is moveable between mold defining and release orientations in a direction generally transverse to the production system axis. Through the utilization of cam tracks and secondary carriage mounted cam followers, molds may be transversely moved between the two noted orientations, for example, at the end of the forming tunnel, the cam followers will follow a diagonally oriented cam track to move from a mold defining to a release orientation and as the carriage assemblies with associated molds are returned to the entrance to the molding system translational cam tracks will cause the followers to move the mold carrying secondary carriages to their mold defining orientations toward the production system axis.

Movement of the molds and associated carriage assemblies about the system is through the utilization of release and feed assemblages, each of which incorporates respective recovery and feed trolleys onto which the primary carriages are driven. In this regard, the release assemblies utilize recovery trolleys which are driven in mutually opposite directions at either side of the system axis to deposit a mold or mold half and associated carriage assembly at a return assembly. Within the return assemblies at each side of the system, molds or mold halves are maneuvered in parallel with the system axis to queue regions prior to their introduction to feed trolley implemented feed assemblies directing each mold half to the earlier noted receiving region.

Each carriage assembly mounted mold or mold half is configured as a generally semi-cylindrically shaped mold body having an internal mold cavity region configured with an outwardly depending sequence of mold crests spaced apart to define a sequence of inwardly depending vacuum support regions. Each mold body further has an outward surface with outwardly disposed annular standoff structures spaced apart to define cooling regions. A sequence of annular insert components, one of each being positioned over an inwardly depending vacuum support region serve to form mold valleys and define readily accessible and uniform vacuum cavities with vacuum openings positioned to draw thermoplastic material toward the mold valley. A cover plate assembly is connected across the mold body standoff structures to define a dual directional cooling airflow system of cooling chambers.

The system also incorporates a mold set configured to form a bell structure. In this regard, the conventional mold body sequence of spaced apart mold crests extend from the vicinity of one mold side surface to the commencement of a bell cavity extending, in turn, to the vicinity of a mold side surface opposite the one side surface. The mold body outward surface is configured having one or more outwardly depending wall pairs defining vacuum support regions. One or more bell vacuum cover components, each positioned within an outwardly depending wall pair of the vacuum support region functions to define an outward vacuum cavity. A bell mold insert component having a bell defining mold profile is positioned within the bell cavity and connected to the mold body internal mold cavity region. This mold insert has one or more vacuum openings communicating with the outward vacuum cavity for drawing thermoplastic material towards the bell defining mold profile.

Other objects of the invention will, in part, be obvious and will, in part, appear hereinafter.

The invention, accordingly, comprises the system and apparatus possessing the construction, combination of elements and arrangement of parts which are exemplified in the following detailed description.

For a fuller understanding of the nature and objects of the invention, reference should be made to the following detailed description taken in connection with the accompanying drawings.

### BRIEF DESCRIPTION OF THE DRAWINGS

FIG. 1 is a top partially schematic view of a corrugated pipe molding system according to the invention;

FIG. 2 is a partial sectional view taken through the plane 2-2 shown in FIG. 1 FIG. 3 is a sectional view taken through the plane 3-3 shown in FIG. 1;

FIG. 4 is a sectional view showing an enlarged portion of FIG. 3;

FIG. 5 is a front elevational view of a mold employed with the system of the invention;

FIG. 5A is a partial sectional view of the mold of FIG. 5 showing a seal and seal cavity;

FIG. 6 is a side view of the mold of FIG. 5;

FIG. 7 is a partial sectional view taken through the plane 7-7 shown in FIG. 5;

FIG. 8 is a side elevational view of a bell-forming mold employed with the system of the invention;

FIG. 9 is a partial sectional view of the mold of FIG. 8;

FIG. 10 is an external side view of the mold of FIG. 8;

FIG. 11 is a partial sectional view illustrating a bell-based union of two pipes molded in accordance with the system of the invention;

FIG. 12 is an end view of a mold supporting carriage assembly according to the invention;

FIG. 13 is a side view of the carriage assembly of FIG. 12;

FIG. 14 is a top view of the mold transporting components of the system of the invention;

FIG. 15 is a top view of a pusher conveyor based mold positioning assembly according to the invention;

FIG. 16 is a side view of the mold positioning assembly of FIG. 15;

FIG. 17 is a top view of a puller conveyor assembly employed with the system of the invention;

FIG. 18 is a side view of the conveyor assembly of FIG. 17;

FIG. 19 is a partial top view of a return assembly shown in FIG. 14 revealing the position of primary and secondary mold supporting carriages in phantom;

FIG. 20 is a top view of a release rail assembly and associated recovery trolley of a release assembly;

FIG. 21 is a side view of the assembly of FIG. 20;

FIG. 22 is an end view of a trolley employed with the system of the invention;

FIG. 23 is a side view of the trolley shown in FIG. 22;

FIG. 24 is a top view of a rail conveyor assembly according to the invention;

FIG. 25 is a side view of the rail conveyor assembly of FIG. 24;

FIG. 26 is a partial sectional view showing the association of a keeper pin assembly and a primary carriage;

FIG. 27 is a partial side view of a carriage assembly according to the invention showing its association with a keeper pin assembly within a queue region of the system;

FIG. 28 is a partial side view of FIG. 27 illustrating the keeper pin assembly;

FIG. 29 is a partial top view of the system of the invention showing one orientation of molds during its operation;

FIG. 30 is a partial top view of the system of the invention showing another orientation of molds in the course of its performance;

FIG. 31 is another partial top view of the system of the invention showing the maneuvering of molds in the production of corrugated pipe; and

FIG. 32 is another partial sectional top view of the system of the invention illustrating the maneuvering of recovery and feed trolleys.

### DETAILED DESCRIPTION OF THE INVENTION

In the discourse to follow the molding system for producing polymeric corrugated pipe is generally described, whereupon the structuring of the shuttle maneuvered mold pairs is addressed. Next, the discussion turns to the unique, endless screw-based dynamic forming tunnel of the system, after which the techniques for recovering mold pairs at the end of the forming tunnel and shuttling them to a queue region is described.

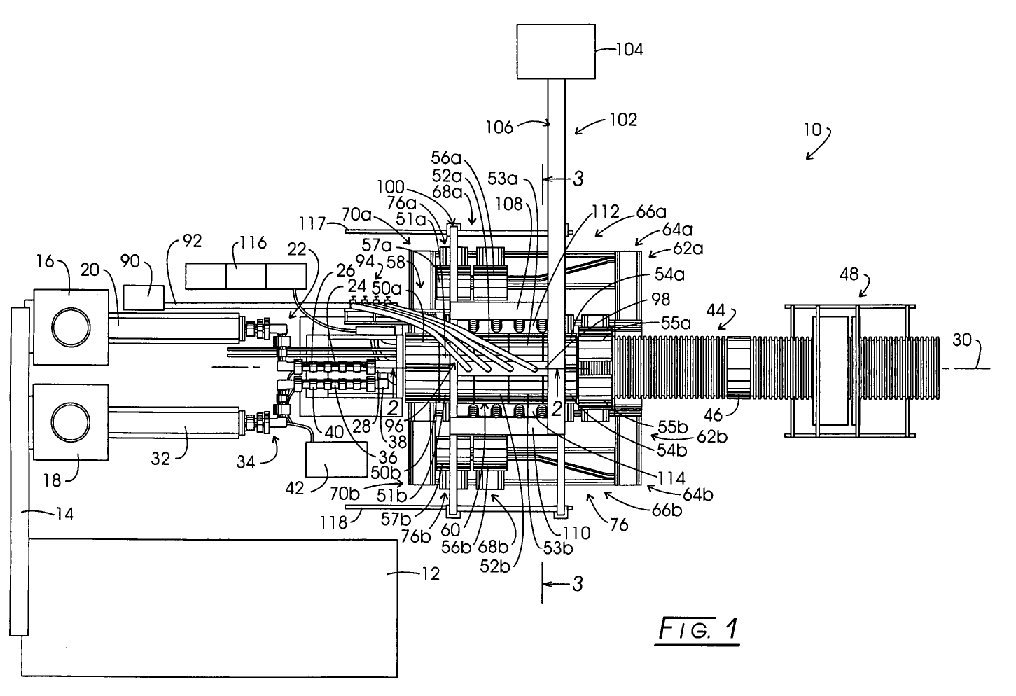

Looking to FIG. 1, the molding system is represented generally at 10. Thermoplastic material is combined with, for example, carbon black at a mixing station represented schematically at block 12. While one source of material and formulation is indicated at block 12, the system 10 can perform with thermoplastic material exhibiting different chemical formulations and/or colors. Mixed thermoplastic materials are transported by a conveyor represented schematically at 14 to apportioning bins or hoppers 16 and 18. Bin 16 is dedicated to providing material for forming the outer corrugated wall of the produced pipe, while bin 18 apportions material for forming the inner liner of the pipe product. Bin 16 provides thermoplastic material to a heated extruder 20. From extruder 20 hot thermoplastic material under substantial pressure is directed through a heated, dual elbow pipe configuration represented generally at 22, whereupon material is directed through a somewhat elongate heated input pipe 24. Heating is provided by numerous electrically energized band heaters, one of which is represented at 26. Pipe 24 inserts melted heated thermoplastic material, for example, at about 400° F., into a manifold or block 28. Block 28 may be seen to be symmetrically disposed about the system axis 30.

In similar fashion, bin 18 provides thermoplastic material to a heated extruder 32 which expresses thermoplastic material under pressure through a dual elbow pipe configuration represented generally at 34 which, in turn, extends to an input pipe 36. Pipe 36 delivers the heated material under pressure through an elbow connection 38 to a side surface located port of manifold 28. As before, a substantial number of band heaters are coupled with pipe 36, one of which is represented at 40. Control to these heaters is provided from a floor-mounted control console 42.

Molded corrugated pipe is represented generally at 44 being continuously extruded by the system 10 along axis 30. The pipe is shown having bell components as at 46 and progresses continuously to a cut-off station represented generally at 48. Station 48 is configured with rotary cut-off saws and is designed to move with the pipe 44 during the process of clamping on to it and carrying out sawing activity.

Eight mold pairs or mold sets 50a, 50b-57a, 57b are employed with exemplary system 10 and are transported about a main frame or structure having horizontally disposed tables within a common place which support guide rails and cam tracks. Conveyance of molds about the system is facilitated through the utilization of dual carriage-based mold supports. In the figure, mold pair 50a, 50b have been joined and located at a receiving region represented generally at 58. At this location, a carriage assembly supporting mold pair 50a, 50b is being pushed or compressibly urged against a similar carriage supporting mold pair 51 a, 51 b which is located at a reference region represented generally at 60. Reference region 60 is located at the entrance of a dynamic forming tunnel. Mold set 54a, 54b is somewhat out of the forming tunnel and each mold of the pair will commence to be parted by a release assembly in the manner shown at mold set 55a, 55b. The release assembly is comprised of paired puller conveyors performing in conjunction with table mounted parting cam tracks which are engaged by the carriage assembly associated with each mold 55a, 55b, the release assembly being symmetrically disposed on either side of axis 30. The puller conveyors will be seen to draw each mold as at 55a, 55b onto a respective exit transport or puller trolley shown in general at 62a, 62b. These exit transport or puller trolleys in general are configured with cam tracks receiving a mold carriage assembly follower which are then driven transversely outwardly to receiving positions shown respectively at 64a, 64b. From these receiving positions each mold or mold set half is drawn into a mold return assembly represented generally at 66a, 66b. These mold return assemblies will be seen to be formed with table mounted rails, cam tracks and conveyor assemblies. The return assemblies 66a, 66b move the mold halves to respective queue regions 68a, 68b. In this regard molds 56a, 56b and 57a, 57b are within respective regions 68a and 68b. At those regions, the mold return assemblies 66a, 66b will have positioned the mold halves with about a one inch axial spacing. In appropriately timed fashioned, the mold return assemblies 66a, 66b will position a mold half onto the table and rail mounted trolleys of respective mold feed assemblies shown generally at 70a and 70b. Those trolleys will move the mold halves mutually inwardly into receiving region 58. In this regard, united mold pair 50a, 50b is shown positioned at that region. When at region 58, the carriage assemblies of these mold pairs are pushed or urged axially into abutment with the carriage assemblies of the mold pair 51a, 51b located at reference region 60. This positioning achieves a proper engagement with an endless screw based transport assembly functioning to drive the mold sets defining a forming tunnel region.

Shown additionally in FIG. 1 is a vacuum pump function represented at block 90. Function 90 may be comprised of, for instance, 4 twenty-five horsepower vacuum pumps. The vacuum output of function 90 is represented at line 92 extending to a vacuum manifold and valve assembly represented generally at 94 from which an array 96 of discrete vacuum lines extend to a four compartment vacuum manifold 98. Manifold 98 is supported upon a frame represented generally at 100. Frame 100 is wheel mounted and also supports an air blower assembly represented generally at 102 and comprised of an air blower function 104; an over and under duct assembly represented generally at 106 which supplies air to axially disposed air manifolds 108 and 110 from each of which flexible hoses depend inwardly to respective mold engaging air manifolds 112 and 114. Those manifolds 112 and 114 supply cooling air centrally to outward chambers formed within each mold of the mold sets within the forming tunnel. Also shown in the figure is a floor mounted control console 116. Additionally mounted upon the facility floor are access rails 117 and 118 upon which the wheel mounted frame 100 rides. This frame maneuvering feature permits more facile access to components such as the die assembly of the system.

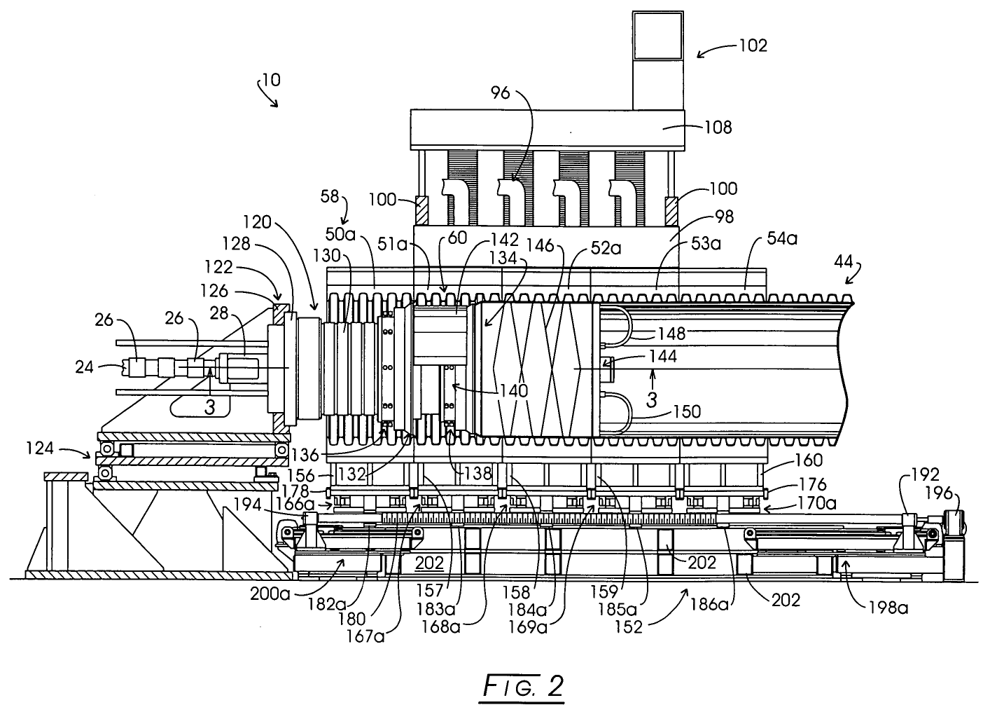

Referring to FIG. 2, the die assembly as well as components of the transport assembly of system 10 functioning to move the mold sets along and defining the forming tunnel are revealed. The die assembly is represented generally at 120 and is described in detail in co-pending application for United States patent by Karr, et al., Ser. No. 10/715760 entitled “Die Apparatus for Forming Corrugated Pipe” filed Nov. 18, 2003 and incorporated herein by reference. Assembly 120 is seen supported in cantilever fashion at die entrance 122 by a robust and adjustable die support assemblage represented generally at 124. In this regard an upstanding flange assembly 126 of the support 124 is coupled to a die mounting ring 128 which, inter alia, supports a heater band enveloped outer wall surface 130 extending to an annular outer wall forming extrusion nozzle represented generally at 132. Located axially forwardly of the outer wall nozzle 132 is an inner wall forming extrusion nozzle represented generally at 134. Material flow and die lip concentricity adjustment assemblages as represented generally at 136 and 138 are located immediately upstream of the respective nozzles 132 and 134. It may be noted that an annular access region represented generally at 140 is protected by a semi-cylindrical shield 142. Attached to the die adjacent inner wall extrusion nozzle 134 is a cylindrical cooling sleeve represented generally at 144 incorporating a spiral pattern of vacuum notches 146. Water circulation inlet and outlet hoses are identified respectively at 148 and 150.

The bottom or main frame of the mold set transportation assemblage of system 10 is represented in the figure in general at 152. Mold sets 50a, 50b-57a, 57b are supported upon this main frame 152 in conjunction with a carriage assembly configured for movement over table mounted rails in association with a centrally disposed transport assembly and a combination of conveyors and trolleys. Mold components 50a through 54a are seen in the figure to be affixed to respective mold support stands 156-160. Stands 156-160, in turn, are mounted upon respective carriage assemblies represented generally at 166a-170a. Carriage assemblies 166a-170a are configured with forwardly and rearwardly disposed bumpers which are engageable from mold set to mold set in freely abuttable fashion. One forward bumper is shown at 176 in connection with carriage assembly 170a, while a rearwardly disposed bumper is shown at 178 in connection with carriage assembly 166a.

The forming tunnel generally is considered to extend the axially length of vacuum manifold 98. Mold sets are maneuvered along this tunnel by a translation component implemented as a continuously rotating endless screw 180. In this regard, partial or half follower nuts are seen extending downwardly from respective carriage assemblies 166a-169a. Of these follower nuts, nut 183a is engaged with screw 180 at the reference region 60 representing the entrance of the forming tunnel. Within the tunnel region, follower nuts 184a and 185a are engaged with screw 180 and mold set 54a, 54b is just exiting the forming tunnel region, its follower nut 186a having come off of the threaded portion of screw 180 and the transverse motion of its mold path to release from the corrugation surface of pipe 44 having commenced. The translation component 180 continuous screw is mounted between bearings 192 and 194 and is driven from an electric motor assembly 196.

The maneuvering of the paired mold set at the receiving region 58 for engagement of its follower nut with the rotating screw 180 is critical with respect to the avoidance of misaligning of the threads of the associated follower nut. While the pitch of the threaded component of the follower nuts is made to equal the pitch of the rotating screw 180, the pitch of the follower nut at the receiving region 58, for example, follower 182a must be so aligned as to, in effect, create a continuous pitch with the screw 180. This calls for a very accurate spacing between the forward and rearward bumpers as at 176 and 178 for each mold set. That spacing must correspond with an integer multiple of the pitch for one or more carriage assemblies. For example, where the common pitch at hand is four threads per inch, then the spacing between the bumpers at each mold set carriage assembly may be 33 inches. That accurate bumper-to-bumper spacing for each mold set then is employed in conjunction with receiving region 58. At that region, two pusher conveyors, one of which is represented in general at 200a urges the downstream or forward bumper of the mold set at the receiving region against the corresponding upstream or rearward bumper of that mold set located at the reference region 60. For example, in FIG. 2 the forward bumper of carriage assembly 166a is being pushed in freely abutting fashion against the rearward bumper of carriage assembly 167a within the reference region 60. Within that region follower nut 183a is engaged with screw 180. Accordingly, the continuous pitch spacing is established.

The paired molds are transversely separated upon exiting the forming tunnel by release assemblies positioned on each side of the axis 30. These assemblies include puller conveyors one of which is revealed in the figure in general at 198a. FIG. 2 also reveals that the main frame 152 is configured with inter connected steel box beams or tubes certain of which are identified at 202

Referring to FIG. 3, a sectional view of system 10 is presented wherein paired molds 53a and 53b are seen to be positioned upon their respective carriage assemblies 168a and 168b in a mold defining orientation wherein they are joined together about die assembly 120. Mold halves 56a and 56b are seen carried by respective mold support stands 162a and 162b and carriage assemblies 172a and 172b. Carriage assembly 172a is located at the queue region 68a of mold return assembly 66a. Correspondingly, mold 56b of the mold pair is supported upon mold support stand 162b and carriage assembly 172b within queue region 68b of mold return assembly 66b. Carriage 66a is seen mounted upon a rail supporting table represented generally at 216a which comprises an upwardly disposed steel plate 218a supported by box beams as at 202 and generally C-shaped rails represented generally at 220a and 221a. The mold halves are maintained in stationary fashion at the queue region 68a by a pneumatically actuated keeper assembly as at 211a.

In similar fashion, carriage assembly 172b is supported upon a rail supporting table 216b which includes an upper steel plate 218b which in turn supports C-shaped rail assemblies 220b and 221b. Mold half 56b is retained in stationary position at the queue region as in 68b by pneumatic keeper assembly represented generally at 211b. Carriage assemblies 172a and 172b are shown in an orientation positioning respective mold halves 56a and 56b in a mold defining orientation which is repeated in connection with carriage assemblies 168a and 168b.

Now looking in general to the structuring of system 10 at the forming tunnel region it may be seen that two table structures represented generally at 224 and 226 are arranged in parallel with and at each side of axis 30. These tables are formed with respective elongate steel plates 228 and 230. Plate 228 is seen to support two parallel C-shaped main rails represented generally at 232a and 232b in addition to a main cam track assembly represented generally at 234. Table structure 226 is similarly structured, plate 230 supporting main C-shaped rails represented generally at 236a and 236b. Additionally, plate 230 supports a main cam track assembly represented generally at 238.

FIG. 4 is an enlarged detail of this center region represented in FIG. 3. Looking momentarily to that figure, it may be observed that carriage assembly 168a is configured with a bumper 240a and a vertically disposed cam follower assembly represented generally at 242a which is configured having a roller component 244a which is movably engaged with main cam track 234. In similar fashion, carriage assembly 168b is configured having a downstream or forward bumper 240b and a cam follower represented generally at 242b which is configured with a roller component 244b. Roller component 244b is engaged in follower fashion with cam track assembly 238. The mechanical association of cam follower assemblies 242a and 242b with respect to cam track assemblies 234a and 234b provide for the manipulation of respective mold halves 56a and 56b along a locus of travel generally transverse to axis 30 between the mold defining orientation shown and an outboard release orientation.

FIG. 4 further shows pusher conveyor 200a as revealed in FIG. 2 and pusher conveyor 200b disposed opposite axis 30. As noted above, these pusher devices engage the rearwardly disposed bumpers of mold set carriages at receiving region 58 (FIG. 1) to urge the carriage bumpers into freely abuttable and compressive engagement with the bumpers of those mold set carriages then located at reference region 60 and thus engaged with screw 180.

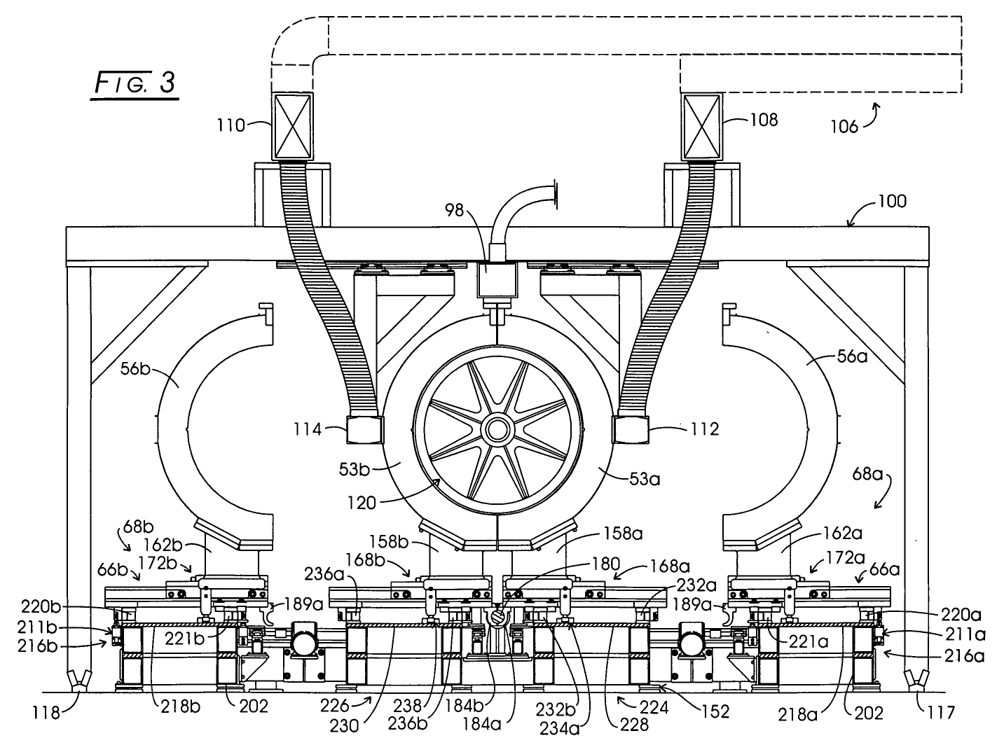

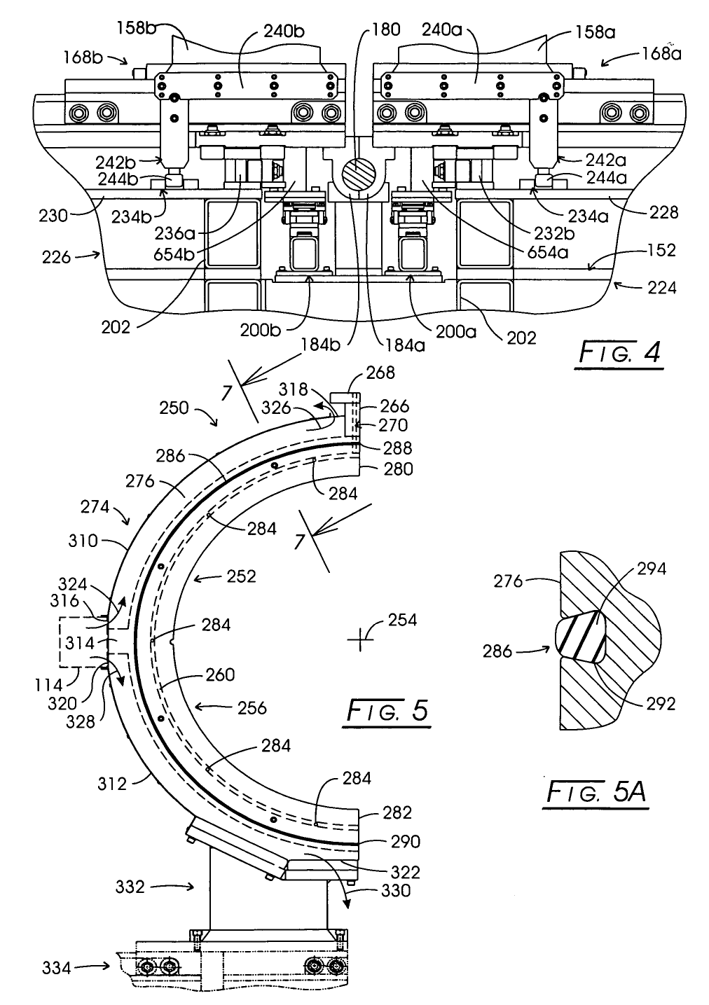

Now looking to the structuring of each mold or mold half of the mold set, reference initially is made to FIGS. 5-7. FIGS. 5 and 6 reveal a mold as represented generally at 250 which comprises a generally semi-cylindrically shaped aluminum mold body represented generally at 252 which is disposed about a mold set axis represented at 254. Mold set axis 254 in general will coincide with system axis 30. Mold body 252 is configured with an internal mold cavity region represented generally at 256 which is formed with an outwardly depending sequence of integrally formed mold crests certain of which are revealed in FIGS. 6 and 7 at 258. Mold crest 258 correspond with the valleys of the ultimately produced pipe 44. Mold crests 258 are spaced apart to define a sequence of inwardly depending vacuum support regions as identified at 260 in FIG. 7. Note that regions 260 have a rectangular cross section. Mounted over each of these vacuum support regions 260 are relatively thin, T-shaped insert components certain of which are identified at 262. FIG. 7 reveals that the stem of each T-shaped insert component 262 functions as a form of standoff as well as threaded bore for receiving the ends of cap screws 364. With this arrangement a mold valley is created as well as a vacuum cavity at support regions 260. Looking to FIGS. 5 and 6, vacuum is applied to those vacuum cavities from an upwardly disposed mold manifold 266. Manifold 266 is configured with an upwardly disposed contact surface 268 which cooperates with the vacuum source manifold described at 98 in FIGS. 1 and 2. FIG. 6 reveals that the manifold is structured to provide discrete bore parts as at 270 which extend to each of the vacuum cavities defined at support regions 260. The mold valleys established by the insert components 262 also are formed with vacuum openings certain of which are identified at 272 in FIGS. 6 and 7. These openings 272 preferably are formed by providing notches within the insert components 262 to achieve the slit-like shape.

Mold body 252 also is configured with an outward surface represented generally at 274; extends along mold set axis 254 between oppositely disposed generally flat mold side surfaces 276 and 278, and extends about mold set axis 254 between oppositely disposed, generally flat mold mating surfaces 280 and 282.

FIGS. 5 and 7 reveal that vacuum passageways as seen at 284 extend to mold side surface 276 and are in vacuum communication with one outboard vacuum cavity. These small bores are provided to assure a proper low pressure at each mold-to-mold interface. Mold-to-mold integrity further is enhanced with the positioning of seals at mold side surface 276 as well as at mold mating surfaces 280 and 282. One such seal 286 is seen in FIG. 5 at side surface 276. Additionally, a seal 288 is seen at mold mating surface 280 and a seal 290 is seen at mold mating surface 282. Looking momentarily to FIG. 5A, seal 286 is seen to be configured as a dovetail-shaped notch 292 within which is inserted a flexible or soft silicon cord 294. One such seal pair as at 288 and 290 is provided for each mold set. Also one seal pair as at 286 is provided at either the upstream or downstream side surfaces of each mold set.

FIG. 7 reveals that mold body outward surface 274 is configured with integrally formed annular, outwardly depending standoff structures 300-303. These standoff structures are configured to establish three cooling regions along the upper half and lower half of the whole outward surface 274. FIG. 7 reveals the three cooling regions 306-308 in the upper half of outward surface 274. These regions are developed as chambers by the attachment of two cover plates to the standoffs. For instance, a top cover plate 310 extends over regions 306-308 and as seen in FIG. 5, a lower cover plate 312 creates air chambers in the lower half of the mold. FIG. 5 reveals that standoff structures are configured to provide a solid air diverting region 314 which permits cooling air to be directed both upwardly and downwardly. To accommodate this arrangement, cover plate 310 is configured to define an air inlet at 316 and an air outlet 318 in the vicinity of mold mating surface 280. In similar fashion, cover plate 312 is configured to provide an air inlet 320 adjacent region 314 and an air outlet 322 adjacent mold mating surface 282. This provides upwardly directed air flow as represented by arrows 324 and 326 and a lower directed air flow as represented at arrows 328 and 330.

Mold body 252 is supported upon a mold support stand represented generally at 332. Stand 332, in turn, is mounted upon a carriage assembly shown in phantom and represented generally at 334.

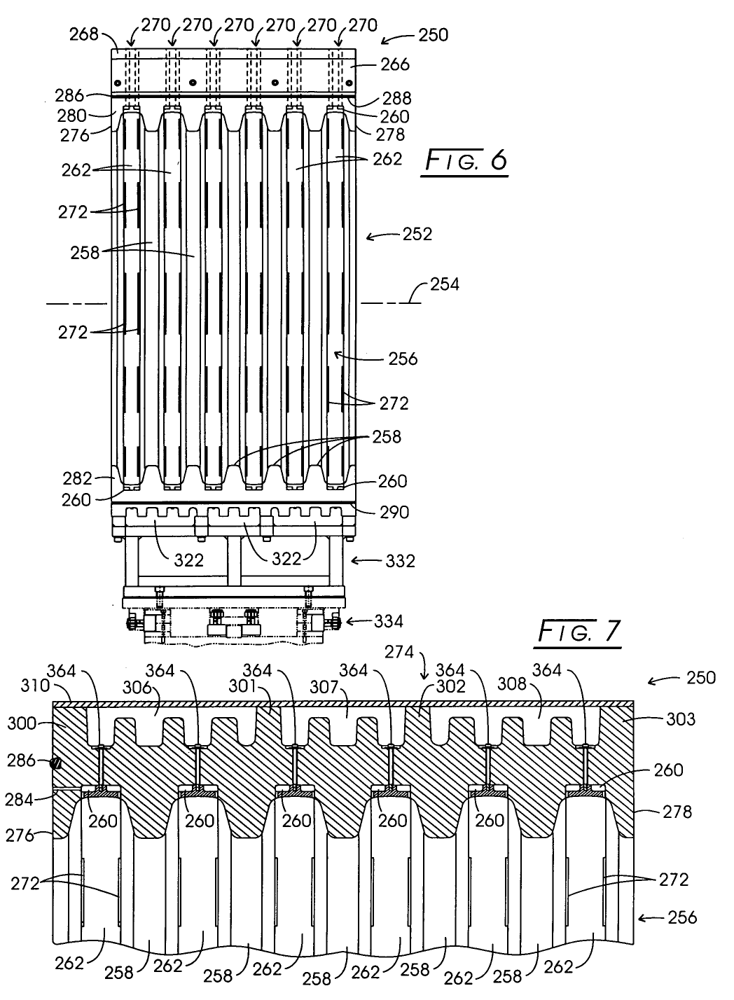

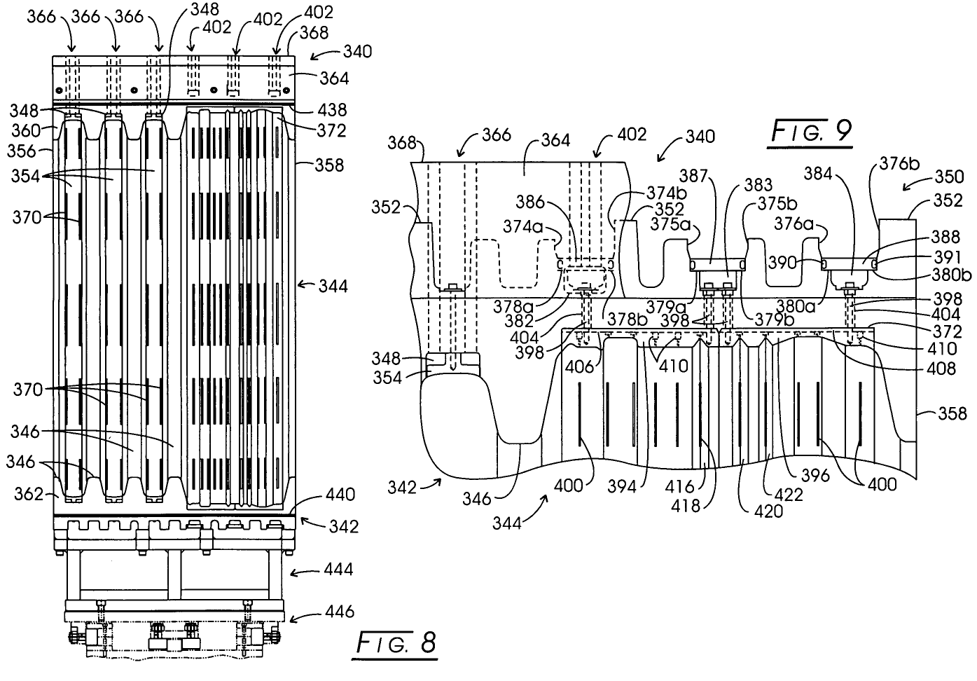

In general, one mold set of the collection employed with system 10 is utilized to form bell structures as described at 46 in FIG. 1. A mold or mold half of such a mold pair is represented in general at 340 in FIGS. 8-10. Mold 340 is formed, as before, with a mold body represented generally at 342 of generally semi-cylindrical shape which is disposed about mold set axis (not shown). The mold body 342 is configured having an internal mold cavity region represented generally at 344 which, as before, is configured with an outwardly depending sequence of mold crests 346 which are spaced apart to define a sequence of three inwardly depending vacuum support regions 348. As seen in FIGS. 9 and 10, the mold 340 further is configured having an outward surface represented generally at 350 with outwardly disposed spaced apart annular standoff structures certain of which are revealed at 352. To form the corrugational components preceding the bell structure, as before, the vacuum support regions 348 are combined with a sequence of annular insert components configured and installed identically with those described at 260 in FIG. 7 and shown in the instant figures at 354. Mold 340 is seen to extend axially between side surfaces 356 and 358 and about its mold set axis (not shown) between oppositely disposed generally flat mold mating surfaces 360 and 362. A mold manifold 364 is positioned at the top of mold 340 adjacent mating surface 360. For the corrugation defining valleys and vacuum support region, as before, paired bores or passageways represented in general at 366 communicate between the mold manifold 364 top surface 368 and the vacuum support regions 348. As before, the vacuum support regions 348 communicate in vacuum transfer relationship with a sequence of slit-defining notches formed within the insert components 354, certain of which are represented at 370.

For the instant bell-forming mold 340, the sequence of mold crests 346 extend from the vicinity of mold side surface 356 to the commencement of a bell cavity 372 which extends to the vicinity of mold side surface 358. Opposite this cavity 372 the mold body outward surface 350 is configured having outwardly depending paired walls as seen in FIG. 9 at 374a, 374b-376a, 376b. Walls 374a, b-376a, b are formed with respective shoulders 378a, b-380a, b below which are formed a respective outward vacuum cavity region 382-384. Each of these outward vacuum cavity regions 382-384 is covered with a respective bell vacuum cover component 386-388. Each of the bell vacuum cover components 386-388 is configured with side edge O-rings, two of which are revealed at 390 and 391 in connection with cover component 388.

Connected within the bell cavity 372 are two bell mold insert components 394 and 396 which combine to define a bell mold profile. Connection of these inserts 394 and 396 is provided by cap screws, certain of which are revealed at 398.

Vacuum is asserted at the bell mold insert components 394 and 396 through slit-shaped openings certain of which are revealed at 400 in FIG. 9. Vacuum is communicated from vacuum manifold 98 (FIG. 1) to the bell shaping region via paired bores represented in general at 402. FIG. 9 shows that these paired bores communicate through the cover components to the vacuum support regions 382-384. From those support regions, passageways or bores, certain of which are shown at 404 communicate with vacuum compartments 406 and 408 formed outwardly of the respective insert components 394 and 396. Bores or passageways, certain of which are shown at 410 the communicate from the vacuum compartments 406 and 408 with the slit or slot-shaped opening at 400. Note in FIG. 9 that bell mold insert component 394 is configured having a triangular-shaped ridge forming cavity 416 also being formed with slit-shaped openings, one of which is revealed at 418. Similarly, bell mold insert component 396 is formed with two such ridge forming cavities as at 420 and 422. Cavities 420 and 422 also are formed with slit-shaped openings similar to that shown at 418. These cavities 416, 420 and 422 serve to form reinforcing ridges extending outwardly from the bell structures. These reinforcing ridges function to maintain the circular integrity of the bell structures where associated corrugated pipe lengths are improperly stored such that bell distorting forces are created.

FIG. 10 reveals that upper covers as at 428 and lower covers as at 430 are coupled by machine screws to the standoffs as at 352. The covers are configured so as to provide air outlets as described in connection with FIG. 5 as well as air inlets as shown respectively at 432 and 433. These inlets are arranged with a solid air diverting region 434 in the same manner as described at 328 in FIG. 5.

One, half mold of a mold pair, for instance, mold 340 additionally is configured with seals in the same manner as described in connection with mold 250. Two such seals are seen in FIG. 8 at 438 and 440 within respective mold mating surfaces 360 and 362. As in the case of mold 250, mold 340 is supported by mold support stand represented generally at 444 in FIG. 8 which, in turn, is mounted upon a carriage assembly, components of which are shown in phantom and in general at 446.

Looking to FIG. 11, the profile of a bell structure developed by molds as at 340 is revealed in connection with mated pipe links 450 and 452. The latter pipe is configured with corrugation crests certain of which is shown at 454-457; an inner liner 458; and extends to a pipe end or edge 460. Pipe 450 is seen, for example having corrugation crest 462 adjacent a bell structure represented generally at 464. Note that that structure incorporates an annular seal cavity 466 within which an annular seal 468 is adhesively attached. Note additionally the presence of bell reinforcing ridges 470-472.

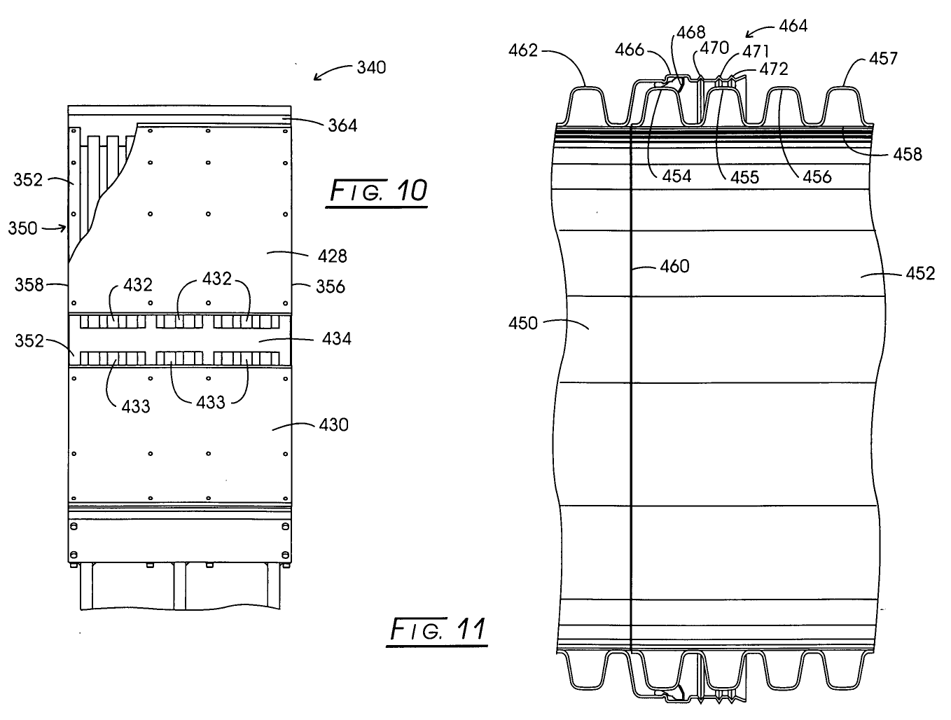

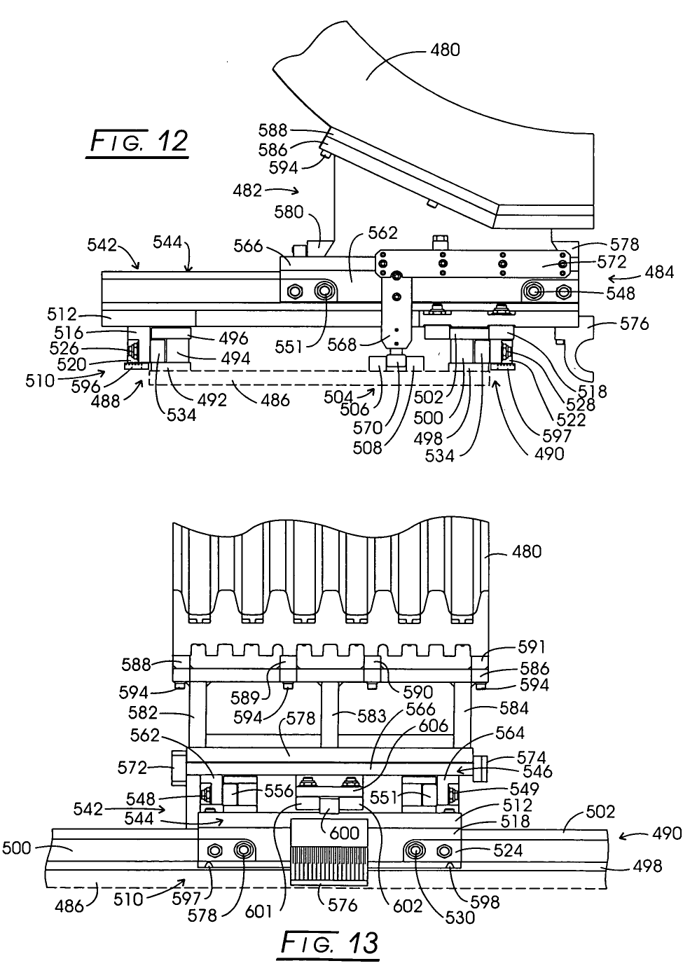

Referring to FIGS. 12 and 13, the mold support stand and carriage assembly associated with each mold or mold half are revealed at a higher level of detail. In the figures, a mold body portion is shown at 480 supported by a mold support stand represented generally at 482 which, in turn, is supported by a carriage assembly represented generally at 484. Carriage assembly 484, is supported upon the upper steel plate 486 of a table within mainframe 152 (FIG. 2). Connected to the upper plate 486 are two generally C-shaped, outwardly opening elongate and spaced apart rails represented generally at 488 and 490. Rail 488 is configured with a lower disposed wear plate 492, an elongate spacer 494 and an upwardly disposed capture plate 496. In similar fashion, rail 490 is configured with a lower disposed wear plate 498, spacer 500 and a capture plate 502. Located parallel with and between the rails 488 and 490 is a cam track (FIG. 12) represented generally at 504 configured with spaced apart elongate cam members 506 and 508.

Carriage assembly 484 is formed of a primary carriage represented generally at 510. Primary carriage 510 generally is configured such that principally it may be drivably moved along a locus of travel which is generally parallel with system axis 30 (FIG. 1). It is configured with a flat base assembly 512 to which are coupled oppositely disposed somewhat elongate blocks 516 and 518. Four cavities are machined into these blocks 516 and 518. In this regard, FIG. 12 shows a cavity 520 machined in block 516 and a cavity 522 machined in block 518. Cavity 518 reappears in FIG. 13 along with a cavity 524 also machined in block 518.

Four axle structures are mounted within the four cavities in blocks 516 and 518. For instance, FIG. 12 reveals an axle structure 526 mounted within cavity 520 and an axle structure 528 mounted within cavity 522. Axle structure 518 reappears in FIG. 13 along with an axle structure 530 mounted within cavity 524. The four axle structures rotatably support four steel wheels. FIG. 12 reveals that axle structure 526 supports wheel 534 which is captured between wear plate 492 and capture plate 496. The figure further reveals that axle structure 528 rotatably supports wheel 534 which is captured between wear plate 498 and capture plate 528. The remaining two wheels and associated axle structures are generally at the opposite corners of the primary carriage 510. The secondary carriage of carriage assembly 484 is represented generally at 542.

FIG. 13 reveals that secondary carriage 542 comprises two generally C-shaped mutually inwardly opening rails represented generally at 544 and 546. Rails 544 and 546 are configured in the same manner as primary carriage rails 488 and 490, incorporating wear plates, capture plates and spacers. Rails 544 and 546 support four steel wheels for captured movement of secondary carriage 542 along a locus of travel transverse to system axis 30 and between mold defining and release orientations. FIG. 13 illustrates two axle structures, 548 and 549 rotatably supporting respective wheels 556 and 557. Axle structure 548 reappears in FIG. 12 in conjunction with a third axle structure 551. These axle structures are mounted within respective blocks 562 and 564 which, in turn, are fixed to a steel plate or base 566. An adjustable cam follower 568 is coupled to block 562 and extends downwardly therefrom. FIG. 12 reveals that cam 568 incorporates a cam roller 570 which is movably engaged between cam members 506 and 508 of a given mainframe table. FIGS. 12 and 13 reveal that coupled to secondary carriage 542 is a forward or downstream steel bumper 572. FIG. 13 shows that spaced along the primary carriage locus of travel or system axis 30 is a rearward or upstream bumper 574. Bumper 574 is configured with an abutment surface which is formed of an ultra high molecular weight plastic (UHMW). Bumper 572 is slightly canted such that upon release of a given mold half, it will be moved slightly forwardly or downstream in the process to avoid damage to the seals described in connection with FIGS. 5 and 6. The axial distance between the abutting surface or surfaces of bumpers 572 and 574 is deemed a reference distance. Additionally, coupled to secondary carriage 544 is a connector assembly configured as a half or partial nut 576. The threaded nut includes a thread pitch which corresponds to the thread pitch of the screw 180 (FIG. 2). These connector assemblies 576 ultimately engage screw 180 in a system axial direction when the molds are in their mold defining orientations establishing a mold set or pair. To assure proper engagement with the threads of screw 180, the reference distance between the abutting surfaces of bumpers 572 and 574 becomes critical. It is established to provide what is considered a continuous thread pitch with respect to screw 180. Thus, the summed reference distances of a combination of abutting mold sets must be an integer value of a multiple of the pitch of the screw and partial nut 576.

Secondary carriage 542 is guided for transverse movement upon primary carriage 510 with a primary carriage mounted cam bar 600. Cam bar 600 is engaged by four follower rollers, two of which are revealed at 601 and 602. Follower rollers 601 and 602 are supported from secondary carriage 542 by a bracket 606. See FIG. 27 to observe secondary carriage wheels 558 and 559 with associated axle structures 550 and 551 as well as follower rollers 603 and 604.

Mold support stand 482 is mounted upon plate or base 566 utilizing two cleats. In this regard, a fixed cleat attached to plate 566 is shown in FIGS. 12 and 13 at 578 and a removable cleat is shown in FIG. 12 at 580.

FIG. 13 reveals that the support stand 482 is configured with three angular webs 582-584 affixed to plate 566 and extending to connection with an aluminum plate. Welded to that aluminum plate 586 are four blocks 588-591. Machine screws, certain of which are revealed at 594 extend through plate 586 and blocks 588-591 to attachment with mold body 480. Finally, the blocks as at 516 and 518 are configured having locking or engagement holes formed in their peripheries for utilization in primary carriage maneuvering. Two such locking holes are shown in FIG. 12 at 596 and 597 and third is shown in FIG. 13 at 598.

Referring to FIG. 14, a plan view of the frame and table arrangement along with conveyors and trolleys is presented. With system 10, paired molds or mold sets are maneuvered along axis 30 by a translation assembly represented generally at 610 comprised of centrally disposed screw 180 mounted between bearings 192 and 194 and rotatably driven by the motor assembly represented generally at 196. The translation assembly 610 also is configured with main tables represented generally at 224 and 226 and provided with respective earlier-described upper plates 228 and 230. Mounted in spaced relationship on these upper plates and in parallel relationship with system axis 30 are earlier described C-shaped main rails. In this regard, main rails 232a and 232b are mounted upon plate 228 and main rails 236a and 236b are mounted upon plate 230. Note that these main rails extend from adjacency with receiving region 58 to pickup regions 614a and 614b within respective release assemblies 62a and 62b. Main cam track 234 reappears from FIG. 4 as mounted upon plate 228 and extending from a main cam track entrance 616a to a main cam track exit 618a. In similar fashion, main cam track 238 extends from main cam track entrance 616b to main cam track exit 618b. These main cam tracks 234 and 238 engage the follower component of a mold half. Such followers have been described at 568 as extending from secondary carriage 542 (FIG. 12). Main cam track 234 is configured with main cam members 620a and 622a and, correspondingly, main cam track 238 is configured with main cam members 620b and 622b. Note that the transversely outwardly disposed main cam members 620a and 620b are mounted with an array of spring retainers certain of which are revealed at 624. Retainers 624 permit horizontal outward transverse movement of the main cam members 620a and 620b in the event of an anomaly occurring with respect to a given mold half during movement through the forming tunnel region. The cam members 620a and 620b are thus permitted to move transversely outwardly against a spring bias.

Returning to pair mold receiving region 58, paired pusher conveyors 200a and 200b of a mold positioning assembly are seen having respective drive pulleys 630a and 630b coupled in driven relationship with a motor and torquing assembly represented generally at 632.

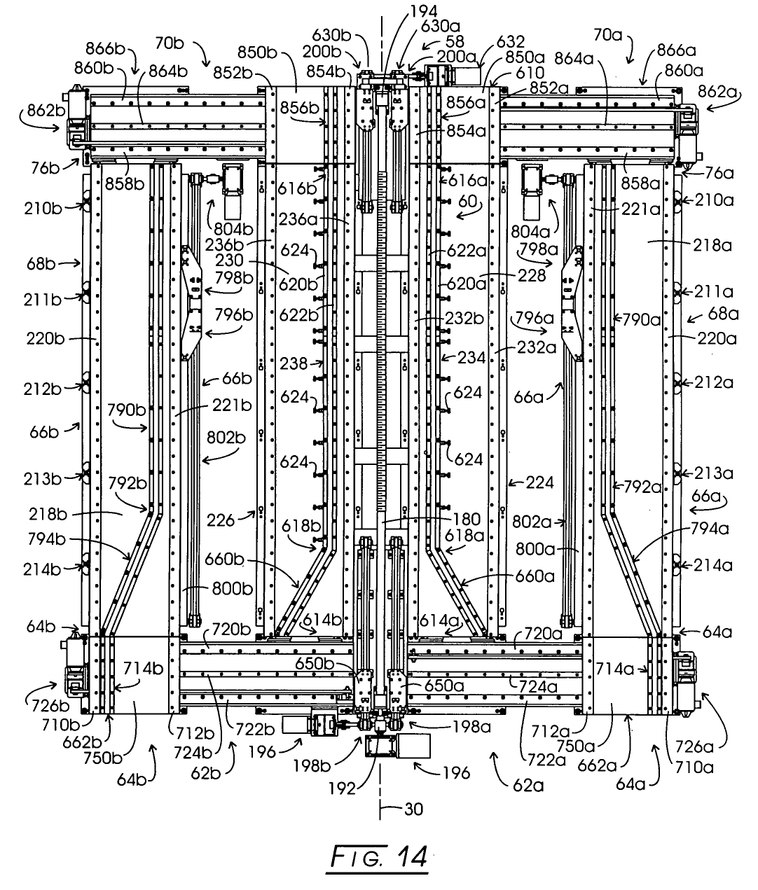

Turning momentarily to FIGS. 15 and 16, pusher conveyors 200a and 200b are illustrated in enlarged detail. FIG. 15 reveals motor and torquing assemblage 632 as being connected by shaft 634 to drive pulleys 630a and 630b. Pulleys 630a and 630b are mounted upon respective box beams 636a and 636b which additionally support idler pulleys 638a and 638b. A belt 640a extends over pulleys 630a and 638a and a similar belt 640b extends over pulleys 630b and 638b. As seen in FIG. 16, the ends of these belts are attached to conveyor trolleys, one being seen in the figure at 642b slidably mounted upon a support 644b and coupled to belt 640b at coupling positions 646b and 648b. Conveyor trolleys as at 642b function additionally to support conveyor plates. In this regard, FIG. 15 reveals conveyor plates 650a and 650b. Connected across these conveyor plates is a pusher assembly represented in these figures in general at 652. Assembly 652 is configured having upstanding pusher components as seen at 654a and 654b. Pusher components 654a and 654b engage the rearward bumpers of a mold set when the mold set is positioned at receiving region 58. Such rearward bumpers have been described at 572 in connection with FIG. 13. As described in connection with FIG. 2, when activated, the pusher conveyors 200a and 200b engage the bumpers of the mold set at the receiving region 58 and moves them synchronously axially forwardly such that the forward bumpers of the mold set carriage assemblies abuttably engage the rearward bumpers of a mold set within the reference region. It may be recalled that the partial nut connector assemblies of the paired molds at the reference region will have been threadably engaged with screw 180. By virtue of the computed reference distance between the bumpers, proper entrance of the next mold pair upon screw 180 is essentially assured.

Returning to FIG. 14, as a mold set emerges from the forming tunnel exit to encounter the release assemblies as described at 62a and 62b, the follower components of the mold secondary carriages will move beyond the main cam track termini 618a and 618b and through the entrances of respective release cam tracks shown at 660a and 660b. Inasmuch as the followers engaged within the upwardly diagonally oriented release cam tracks 660a and 660b are coupled with the secondary carriages, the molds will be moved along a locus transverse to system axis 30 to outboard release orientations. However, the primary carriages will continue moving along the main rail pairs into the pickup regions 614a and 614b. Movement through the pickup regions is carried out by the paired puller assemblies 198a and 198b. These conveyor assemblies respectively will pull the primary carriages of each mold onto a recovery trolley. These two recovery trolleys are represented generally at 662a and 662b which in the instant figure are located at respective receiving positions 64a and 64b. However, the conveyors 198a and 198b will load these trolleys at respective pickup regions or positions 614a and 614b.

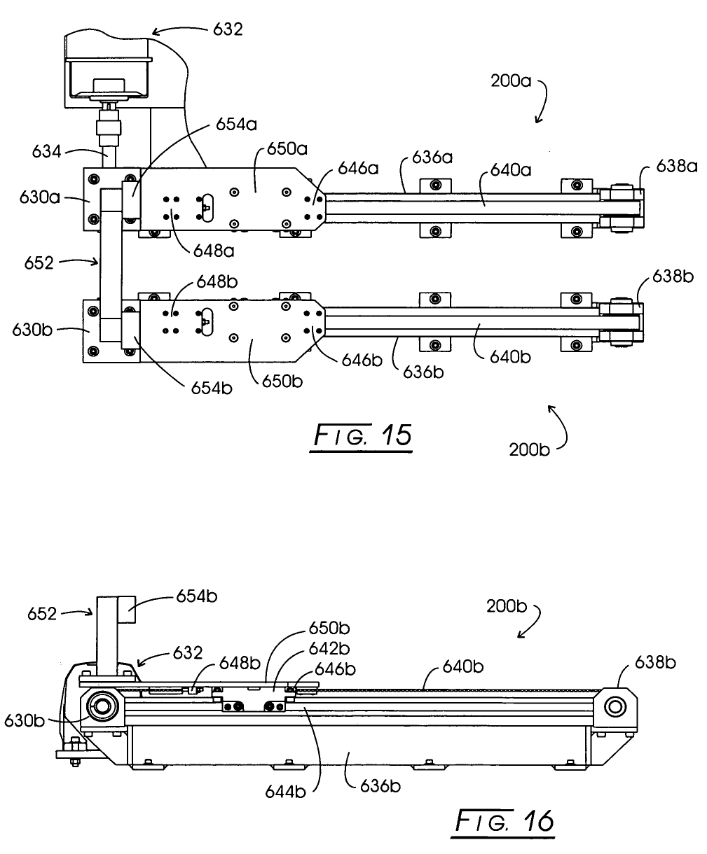

Looking momentarily to FIGS. 17 and 18, puller conveyors 198a and 198b are illustrated at an enhanced scale. Conveyors 198a and 198b incorporate respective drive pulleys 664a and 664b and idler pulleys 666a and 666b. These pulleys are mounted upon respective box beams 668a and 668b. Extending over pulleys 664a and 666a is a belt 670a and extending over pulleys 664b and 666b is belt 670b. Motor and gear assembly 196 is seen providing common drive to drive pulleys 664a and 664b through a shaft assembly 672. FIG. 18 reveals that belt 670b is coupled at connection position 674b to a conveyor trolley 676b. The opposite side of belt 670b is seen to be connected to conveyor trolley 676b at connection location 680b.

Attached to the top of each conveyor trolley are conveyor plates 682a and 682b. Note in FIG. 18 that conveyor plate 682b supports a pneumatically actuated pin assembly represented generally at 684b. When actuated, engagement pins as at 686a and 686b are driven upwardly to engage holes or bores formed upwardly into the bottoms of the primary carriage assemblies. Such a hole has been described at 598 in connection with FIG. 13.

Returning to FIG. 14, as a mold pair moves off of the threads of screw 180 puller conveyors 198a and 198b will be actuated to move the conveyor plates 682a and 682b axially upstream until the engaging pins 686a and 686b enter corresponding holes within the primary carriages of each mold. The conveyor then is reversed and the primary carriages then are drawn along the translation assembly main rails to the pickup positions 614a and 614b, whereupon the carriage assemblies are loaded on the recovery trolleys as at 662a and 662b which will be located at those pickup positions.

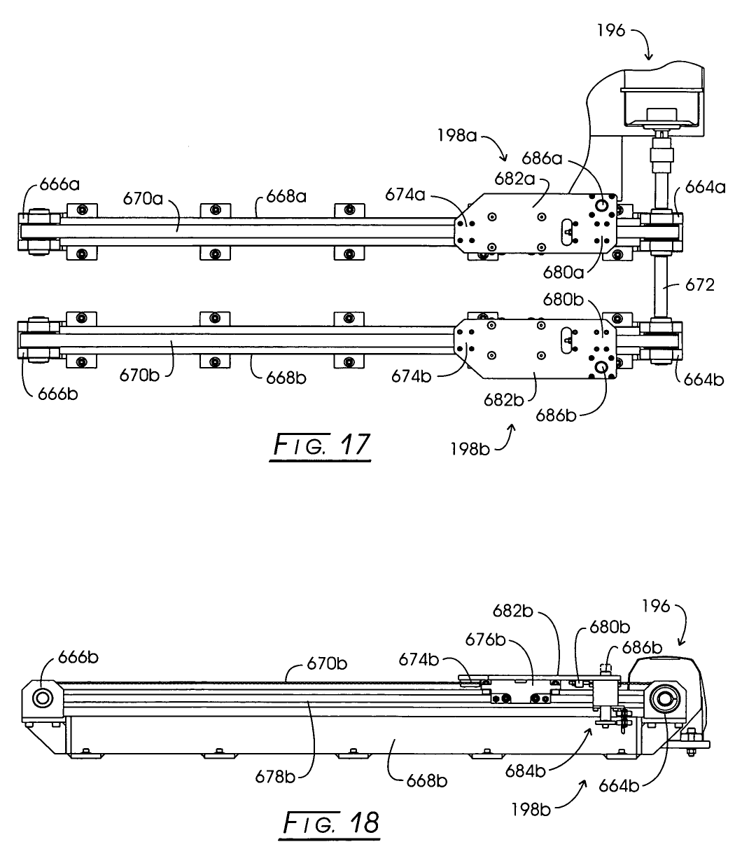

Referring additionally to FIG. 19, the functioning of these release assemblies is illustrated. In the figure, primary carriages are represented in phantom at 690a-692a. These primary carriages are associated with secondary carriages represented in phantom respectively at 694a-696a. The partial nut couplers fixed to the secondary carriages are represented at 698a-700a. Forward bumpers coupled to primary carriages 690a-692a are shown respectively at 702a-704a and corresponding rearward bumpers shown respectively at 706a-708a. Note that the partial nut couplers 698a and 699a of respective primary carriages 690a and 691a are engaged with the threads of screw 180, these secondary carriages being in their mold defining orientation within a forming tunnel. However, primary carriage 692a has been engaged by the engaging pin 686a of puller conveyor 198a. Accordingly, the follower of the secondary carriage 696a will have entered and engaged with release cam track 660a to commence movement of the secondary carriage 696a transversely outwardly from system axis 30. Note that the partial nut connector assembly 700a of primary carriage 692a remains adjacent the unthreaded portion of screw 180 as it continues to ride upon main rails 232a and 232b. To protect the seals described in connection with FIG. 5, forward bumper 703a is canted a slight amount causing bumper 708a of primary carriage 692a to move forwardly with primary carriage 692a. Thus the mating surfaces are parted as the secondary carriage commences to move transversely towards it release orientation.

Note that puller trolley 662a is at the pickup position 614a and that generally C-shaped puller trolley rails 710a and 712a are aligned with respective main rails 232a and 232b. Additionally its recovery trolley cam track 714a is now aligned with the exit of release cam tract 660a. This arrangement is repeated in release region 62b.

Returning to FIG. 14, release assemblies 62a and 62b are seen having respective paired release rails 720a, 722a and 720b, 722b extending transversely outwardly from system axis 30 over which respective wheeled recovery trolleys 662a and 662b are driven. Additionally, intermediate these rails are respective recovery trolley cams 724a and 724b. Drive is imparted to recovery trolleys 662a and 662b by respective motor and gear train assemblies represented in general at 726a and 726b. Note that the assemblies 726a and 726b are situated in axially reversed orientations. With that exception, the release rails, recovery trolley cams and associated drive arrangements are identical.

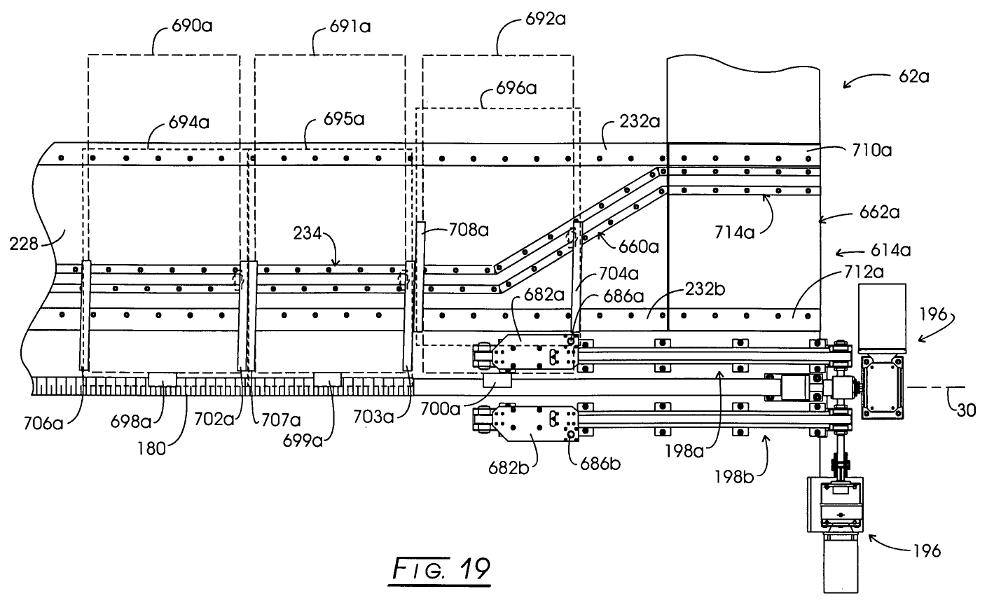

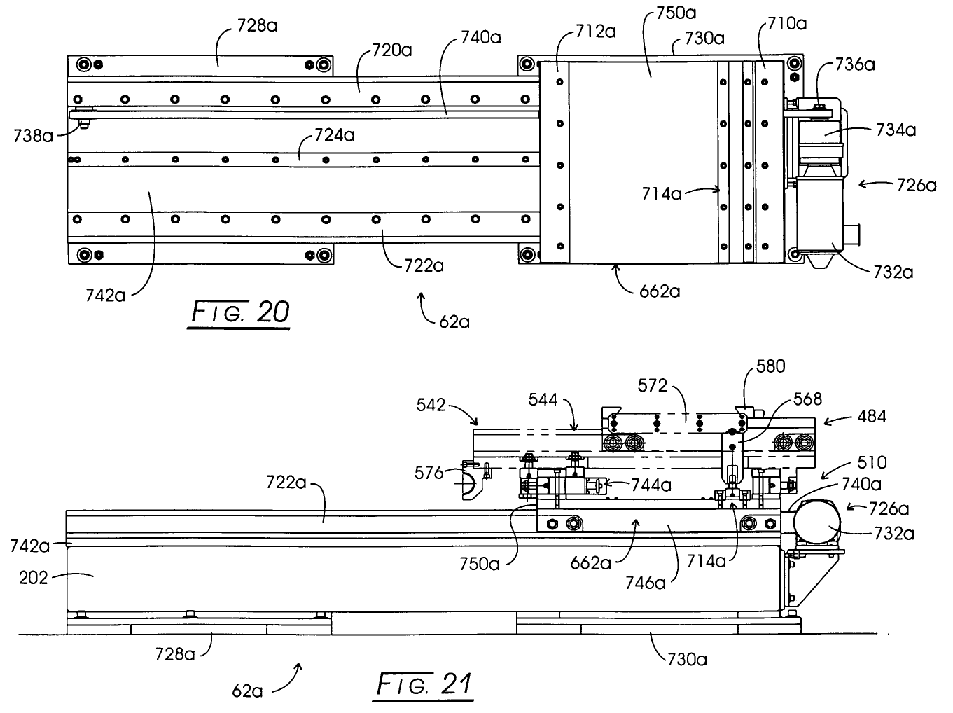

Looking additionally to FIGS. 20 and 21, these components at release region 62a are illustrated at enhanced scale level. FIG. 20 reveals plate base members 728a and 730a over which the release trolley rails 720a and 722a ultimately are supported. Motor assembly 726a is seen to comprise the electric motor 732a and a gear assembly 734a associated in driven relationship therewith. Gear assembly 734a is coupled with a drive pulley 736a. Spaced from drive pulley 736a is an idler pulley 738a. A drive belt 740a extends over pulleys 736a and 738a and is coupled in driving relationship to recovery trolley 662a.

Looking to FIG. 21, generally C-shaped rail 722a reappears being supported by an upper plate 742a, in turn supported by box beam 202 which is mounted upon the base members 728a and 730a. FIG. 21 reveals recovery trolley 662a in conjunction with a carriage assembly. Such carriage assemblies have been described above in connection with FIGS. 12 and 13. Accordingly, the same identifying numeration is employed with respect to the components thereof. To lock the components of the carriage assembly 484 in place during transit on the trolley such as recovery trolley 662a, a pneumatically actuated pin assembly represented generally at 744a is actuated to engage a portion of it. Additionally shown in FIG. 21 is one of the wheel supporting recovery trolley side blocks 746a.

Looking to FIG. 22, recovery trolley 662a reappears in an end view fashion. Note that the assembly is configured with a plate-shaped recovery trolley base 750a and supporting recovery trolley rail 712a and downwardly depending wheel supporting side blocks 746a and 748a. Blocks 746a and 748a support four steel wheels, two of which are revealed at 752a and 753a. Rail 722a is seen to be formed with a wear plate 758a, a spacer 760a and a capture plate 762a. The latter capture plate 764a functions to retain the recovery trolley 662a from overturning.

Release rail 720a is similarly structured, having a wear plate 764a, a spacer 766a and a capture plate 768a. Also shown in FIG. 22 are two of four trolley cam follower rollers 770a and 771a which are mounted upon a roller mount 774a depending downwardly from base 750a. Note that follower rollers 770a and 771a are in rolling and following engagement with sides of recovery cam 724a.

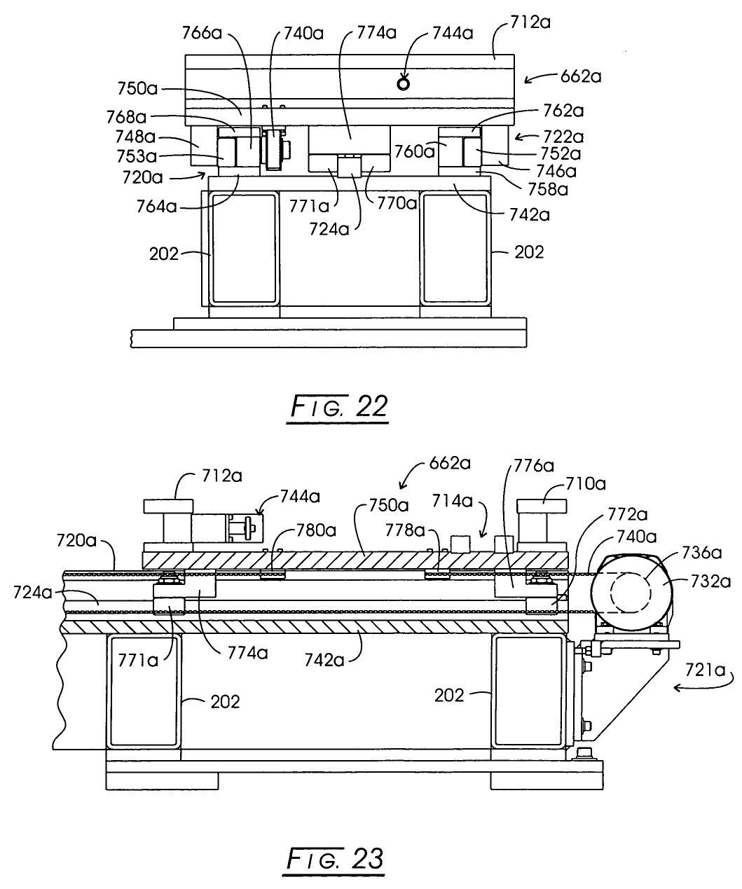

Looking to FIG. 23, follower roller 771a reappears in conjunction with roller mount 774a. Spaced from that follower assemblage is another follower assemblage comprised of roller mount 776a and cam follower roller 772a. The figure further reveals the attachment of belt 740a with trolley 662a. In this regard, the belt is coupled to base 750a at attachment positions 778a and 780a.

Returning to FIG. 14, recovery trolleys 662a and 662b are shown positioned at the respective receiving positions 64a and 64b of mold return assemblies 66a and 66b. As is apparent, return assembly 66b is a mirror image of return assembly 66a. Return assemblies 66a and 66b are configured with respective return rails 220a, 221a and 220b, 221b. These return rails are seen to be parallel with axis 30 and extend from respective receiving regions 64a, 64b and associated queue regions 68a and 68b to forwardmost mold positions represented respectively at 76a and 76b. The return rails are mounted upon respective table defining upper plates 218a and 218b. Additionally mounted on upper plates 218a and 218b are respective rail cam tracks represented generally at 790a and 790b. These rail tracks are seen to be parallel with axis 30, extend from respective forwardmost feed positions 76a and 76b to respective return entrance positions 792a and 792b. Note that cam tracks 790a and 790b are positioned such that the secondary carriage cam followers engaged between them will be retained in a mold defining orientation disposed inwardly towards system axis 30. The entrances 792a and 792b of the rail cam track assemblies are connected with the exits of respective return transition cam tracks represented generally at 794a and 794b. These transition cam tracks extend diagonally inwardly toward axis 30 from respective receiving positions 64a and 64b and when engaged by a secondary carriage follower will cause the associated secondary carriage to move from its release orientation and toward its mold defining orientation.

Note additionally in FIG. 14 that the recovery trolley cam tracks 714a and 714b of respective recovery trolleys 662a and 662b are aligned with the entrances of the respective return transition cam tracks 794a and 794b. Thus, the followers of the secondary carriages readily will be engaged within return transition cam tracks 794a and 794b.

Movement of the primary carriages within mold return assemblies 66a and 66b is provided by return conveyor assemblies represented in general at 796a and 796b. These return conveyor assemblies are formed with respective return engagement components 798a and 798b which are driven over respective return box beams 800a and 800b by respective return belt assemblies 802a and 802b. Return belt assemblies 802a and 802b are driven by respective electric motor assemblies represented generally at 804a and 804b.

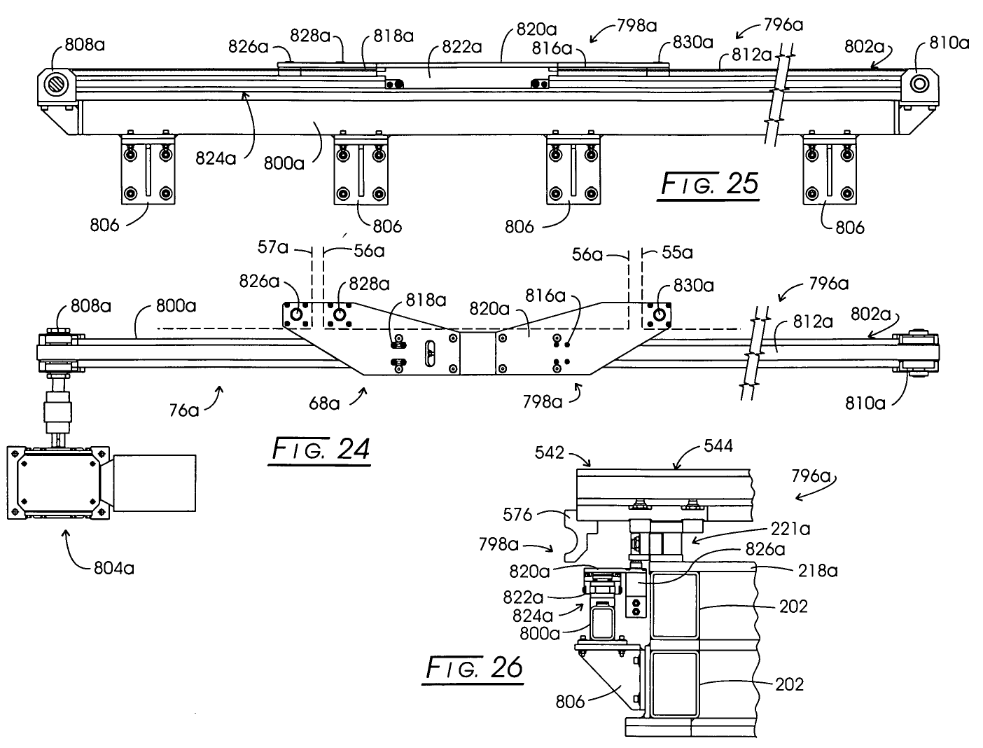

Referring to FIGS. 24-26 the return conveyor assembly 796a is illustrated at an enhanced scale. Assembly 796b is a mirror representation of assembly 796a. In FIGS. 24 and 25 return box beam 800a is shown to be supported from angle supports, certain of which are identified at 806. The beam 800a, in turn, supports return drive pulley 808a and an idler pulley 810a, a return belt 812a extends over pulleys 808a and 810a and is attached to return engagement component 798a at attachment positions 816a and 818a. Drive pulley 808a is seen in FIG. 24 to be coupled in driven relationship with motor assembly 804a. Return engagement component 798a is configured with a return plate component 820a. As seen in FIGS. 25 and 26, return plate component 820a is mounted upon a return conveyor trolley 822a which is retained and positioned upon beam 800a by an elongate return cam bar assembly represented generally at 824a. Follower members (not shown) mounted with the return conveyor trolley 822a follow along this cam bar assembly 824a as the return engagement component 798a is driven from motor assembly 804a. Engagement components 798a is configured to engage the underside of the primary carriages of from one to three mold supporting carriage assemblies. Such engagement is developed by solenoid actuated return engagement pin assemblies seen in FIGS. 24 and 25 at 826a, 828a and 830a. In this regard engagement pin assembly 826a is revealed in plan view in FIG. 26. As before, in FIG. 26 the general identifying numeration set forth with respect to carriage assembly 484 described in connection with FIGS. 12 and 13 is carried forward.

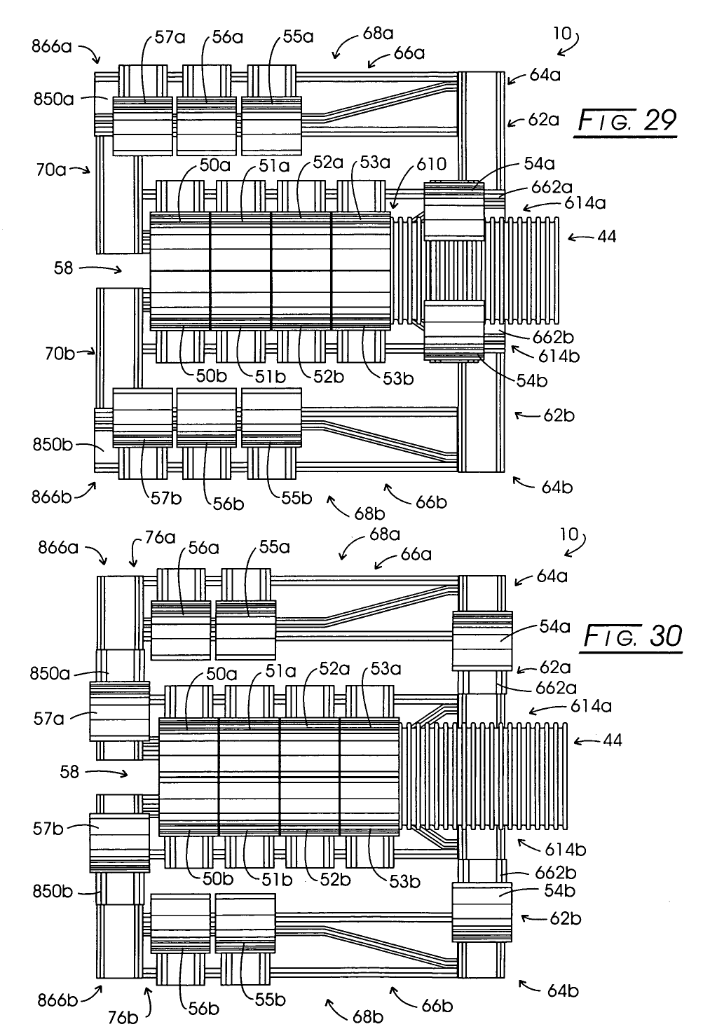

At such time as return conveyor assembly 796a will have retrieved a mold or mold half from a receiving position as described earlier at 64a it will return while engaged with an associated primary carriage utilizing return pin assembly 830a to the queuing region 68a where it will reengage, for instance, to primary carriages including that at the forwardmost position. In FIG. 29, for example, the return engagement component 798 is represented as having engaged the primary carriage components of molds 55a-57a. In this regard, return pin assembly 830a will have engaged the primary carriage of mold 55a; the pin assembly 828a will have engaged the primary carriage of mold 56a; and pin assembly 826a will be in engagement with the primary carriage of mold 57a. Mold 57a is shown schematically at the forwardmost position 76a preparatory to being maneuvered onto the mold feed assembly 70a. Assemblies as at 826a-828a and 830a are axially spaced such that adjacent bumpers of the primary carriages are spaced apart about one inch when located at the queue regions 58a and 58b. When at these two regions, the primary carriages are secured by appropriate ones of the pneumatic keeper assemblies described in conjunction with FIG. 14 at 210a, b-214a, b.

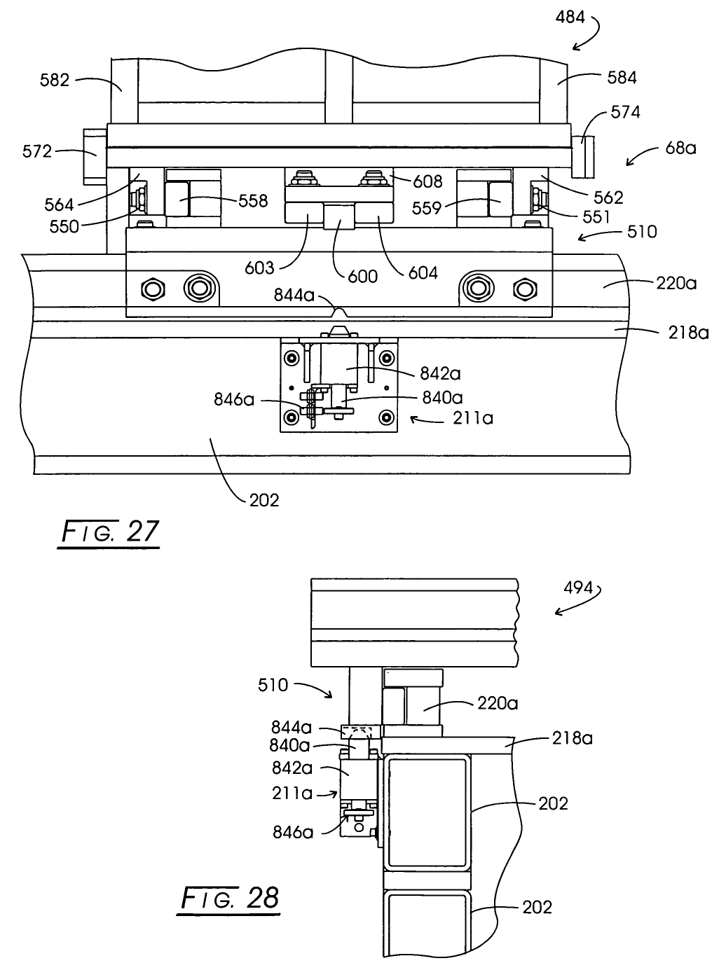

Referring to FIGS. 27 and 28, this keeper or securement arrangement is illustrated at a higher level of detail. A portion of the primary carriage 510 of carriage 484 as described in connection with FIGS. 12 and 13 is imported into the instant figures. Keeper assembly 211a is shown coupled to beam 202 supporting plate 218a and C-shaped return rail 220a. The assembly 211 a is comprised of a keeper pin 840a which is driven upwardly from its home or un-extended orientation as shown into engagement with a notch as at 844a within a wheel supporting block of primary carriage 510. This engagement is facilitated by a chamfering of the upper edge of pin 840a. Assembly 211a further includes a pin location sensor assemblage represented generally at 846a. FIG. 28 illustrates the upwardly disposed or keeping orientation of the keeper pin 840a.

Returning to FIG. 14, mold feed assemblies 70a and 70b are configured essentially identically with the trolley and rail components of release assemblies 62a and 62b. In this regard, feed trolleys are shown at 850a and 850b. The upper surface of feed trolley 850a is seen to support parallel axially aligned C-shaped feed trolley rails 852a and 854a. Correspondingly, the upper surface of feed trolley 850b is seen to support corresponding feed trolley rails 852b and 854b. The upward surfaces of feed trolleys 850a and 850b further support respective feed trolley cam tracks represented generally at 856a and 856b. Feed trolleys 850a and 850b are configured essentially identically with respective recovery trolleys 662a and 662b with the exception of the location of these feed trolley cam tracks. Feed trolley cam tracks 856a and 856b are located for alignment with respective return cam tracks 790a and 790b as well as main cam track assemblies 234a and 234b. Feed trolley 856a rides upon C-shaped feed rails 858a and 860a, while feed trolley 850b rides upon corresponding C-shaped feed rails 858b and 860b and is driven from corresponding motor and belt assembly 862b. Mounted on the surface or plate members supporting the feed rails are feed trolley cams 864a and 864b. C-shaped feed rails 858a, 860a and 858b, 860b as well as electric motor and belt assemblies 862a, b and feed trolley cams 864a, b are configured identically as the corresponding components at release or at the transport assemblies 62a and 62b. However, for the feed operation, the feed trolleys 850a and 850b move between receiving region 58 as shown in the figure and respective acquisition regions represented generally at 866a and 866b providing for alignment with the corresponding return assemblage.

FIGS. 29-32 illustrate the maneuvering of molds or mold halves 50a, b-57a, b within the system 10. Looking to FIG. 29, mold pair 50a, 50b have been united and their partial nut connector assemblies have commenced to engage screw 180. Mold pairs 50a, b-53a, b are establishing the forming tunnel. Mold pair 53a, b are approaching the release assembly 62a to be parted. Mold pair 54a, b are well within the release assemblies 62a, 62b and are approaching respective pickup regions 614a and 614b. Mold pair 57a, b is being driven rearwardly in combination with mold pairs 56a, b and 55a, b, molds 57a and 57b being maneuvered into respective acquisition positions 866a and 866b. Note that feed trolleys 850a and 850b are at those positions for this loading procedure.

Looking to FIG. 30, feed trolleys 850a and 850b are maneuvering respective molds 57a and 57b towards receiving region 58. United mold pair 50a, b now represents a reference mold pair with respect to mold pair 57a, b. Molds 56a and 56b now are located within respective queue regions 68a, b at respective forwardmost positions 76a and 76b. Molds 55a and 55b also are in respective queue regions 68a and 68b and their bumpers are spaced about one inch from the rearwardly disposed adjacent molds. Downstream, recovery trolleys 662a and 662b are moving respective molds 54a and 54b outwardly toward receiving positions 64a and 64b. The dynamic mold forming tunnel continues to be established by mold pairs 50a, b-53a, b.

Turning to FIG. 31, mold pair 57a, b have been joined at receiving region 58 and have been pushed downstream by the pusher conveyors 200a, b of the mold positioning assembly to the extent their half-nut connector assemblies have engaged screw 180. This pushing will have been against the reference mold pair 50a, b and the forming tunnel is being established by mold pairs 57a, b, 50a, b, 51a, b and 52a, b. Molds 53a and 53b are releasing and a slight axial gap is being formed at the abutting bumper surfaces of the primary carriages of molds 52a and 53a by virtue of the earlier-described slight cant or slope in the forwardmost bumper. Molds 54a and 54b are being moved off respective recovery trolleys 662a and 662b at receiving positions 64a and 64b. This movement is driven by the earlier described return conveyor assemblies 796a and 796b. Molds 56a, 56b remains at respective forwardmost positions 76a and 76b, while molds 55a and 55b remain within respective queue regions 68a and 68b in slight spaced adjacency with respect to the forwardmost positioned molds.

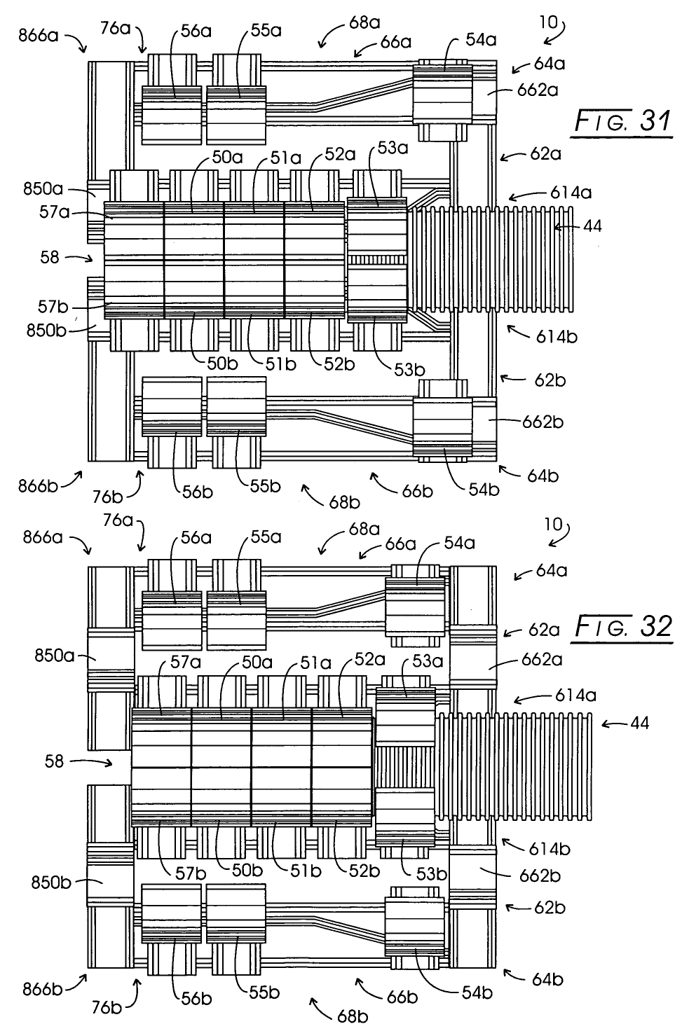

Looking to FIG. 32, the partial nut connector assemblies of the primary carriages of mold pair 57a, b remain engaged the translation assembly screw 180. Thus the mold pair 57a, b continue to establish a forming tunnel additionally comprised of mold pairs 50a, b-52a, b. Molds 53a and 53b are fully within respective release assemblies 62a and 62b and the recovery trolleys 662a and 662b are being driven inwardly towards respective pickup positions 614a and 614b. Molds 54a and 54b, are being moved rearwardly within the respective return assemblies 66a and 66b and the secondary carriages thereof are being maneuvered from mold release orientations toward mold defining orientations. Mold 56a and 56b remain located at the adjacent forwardmost position 76a and 76b of respective queue regions 68a and 68b. Molds 55a and 55b remain in those respective queue regions 68a and 68b while feed trolleys 850a and 850b are driven transversely outwardly toward respective acquisition positions 866a and 866b.

Since certain changes may be made in the above system and apparatus without departing from the scope of the invention herein involved, it is intended that all matter contained in the above description or shown in the accompanying drawings shall be interpreted as illustrative and not in limiting sense.

1. A system for producing corrugated pipe by maneuvering paired molds about a die assembly generally disposed about a system axis and having a paired mold receiving region, a paired mold reference region, an annular die nozzle spaced from said reference region at the entrance of a forming tunnel region defined by an abutting sequence of paired molds extending to a forming tunnel exit, comprising:
a plurality of paired molds, each mold having a generally semi-cylindrically configured corrugate mold profile and dynamically connectable with a vacuum source and a cooling fluid, each said mold being supported upon a carriage assembly having a first locus of travel generally parallel with said axis and a second locus of travel generally transverse to said axis extending between mold defining and release orientations and each said carriage assembly having a connector assembly drivable to move said mold in a direction generally parallel with said axis;
a translation assembly extending in parallel relationship with said axis generally from said reference region to said forming tunnel exit location and engageable in driving relationship with the connector assemblies of said paired molds to effect their movement through said forming tunnel region along said first locus of travel when their associated carriage assemblies are in said mold defining orientation;
first and second mold return assemblies each spaced outwardly from said axis and configured to receive one mold of each mold pair at a respective first and second receiving position and to drivably move each said received mold to respective first and second queue regions having respective first and second forwardmost feed positions and to move each mold at said first and second forwardmost feed positions to respective first and second acquisition positions;
first and second release assemblies respectively drivably engageable with one mold of a said mold pair generally subsequent to movement of said mold pair through said forming tunnel region and configured to drive the carriage assembly of each said mold along said second locus of travel into said release orientation and move said molds to respective said first and second receiving positions;
first and second mold feed assemblies configured to move the molds of a mold pair from respective said first and second acquisition positions to a paired mold receiving region; and
a mold positioning assembly engageable with a mold pair at said receiving region and configured to move said mold pair at said receiving region into abutting engagement with a mold pair located at said reference region.

2. The system of claim 1 in which:
said first and second return assemblies are configured to maneuver respective said mold carriage assemblies along said second locus of travel into said mold defining orientation.

3. The system of claim 1 in which:
said translation assembly comprises a screw assembly having a screw axis generally parallel with said system axis and drivably rotatable about said screw axis; and
each said mold connector assembly is configured as a partial follower nut engageable in driven relationship with said screw assembly.

4. The system of claim 3 in which:
said screw assembly is configured having a screw thread pitch; and
said partial follower nut is configured with nut threads having a thread pitch corresponding with said screw thread pitch.

5. The system of claim 4 in which:
each said carriage assembly is configured having rearward and forward bumpers having abutment surfaces wherein said mold positioning assembly effects the abutting engagement of the abutment surfaces of forward bumpers of a mold pair at said receiving region with the abutment surfaces of rearward bumpers of a mold pair at said reference region, said abutment surfaces of said rearward and forward surfaces being spaced apart along said first locus of travel a reference distance effective to locate said nut threads in continuous pitch relationship with said screw thread pitch.

6. The system of claim 5 in which:
either said reference distance or the sum of reference distances for a sequence of mutually abutting surfaces of rearward and forward bumpers is an integer multiple of said thread pitch.

7. The system of claim 1 in which:
each said mold supporting carriage assembly comprises a primary carriage having one or more wheels effective to transport said carriage assembly along said first locus of travel, and a secondary carriage coupled in supporting relationship with a said mold movable upon said primary carriage along said second locus of travel and having a follower extending therefrom;
said translation assembly further comprises first and second main cam tracks generally in parallel with and spaced transversely from said axis and respectively receiving a said follower of a said carriage assembly of one mold of a mold pair during movement thereof from said reference region and generally through said forming tunnel region to respective first and second main cam track termini, said first and second main cam tracks being transversely located to retain said carriage assembly in said mold defining orientation.

8. The system of claim 7 in which:
said first and second main cam tracks are configured having two generally parallel elongate main cam members spaced apart to receive a said follower, the transversely outwardly disposed main cam members being moveable transversely outwardly from said axis against a spring bias.

9. The system of claim 7 in which:
said first and second release assemblies are configured to engage the primary carriages of the molds of a said mold pair as it emerges from said forming tunnel exit to effect movement thereof along said first locus to respective first and second pick-up regions and thence to move said primary carriages mutually oppositely transversely to said system axis to respective said first and second receiving positions.

10. The system of claim 9 in which:
said translation assembly further comprises first and second main rail assemblies generally in parallel with, spaced transversely from and generally extending from adjacency with said reference region to respective said first and second pick-up regions and configured to receive said primary carriage one or more wheels.

11. The system of claim 10 in which:
said first and second release assemblies further comprise respective first and second release cam tracks having entrances at respective said first and second main cam track termini and extending mutually diagonally outwardly from said system axis for receiving a said secondary carriage follower and effecting the movement of an associated secondary carriage along said second locus of travel toward said release orientation.

12. The system of claim 11 in which:
said first and second release cam tracks are configured having two generally parallel release cam members spaced apart to receive a said follower.

13. The system of claim 10 in which:
said first and second release assemblies comprise respective first and second puller conveyor assemblies having respective first and second engagement components each engageable with a said primary carriage as a said mold pair is generally adjacent said forming tunnel exit and drivably movable therefrom to respective said first and second pick-up regions; and
first and second recovery trolleys drivably movable generally transversely to said system axis between respective said first and second pick-up regions and respective said first and second said receiving positions, each said first and second recovery trolley being configured to receive a said primary carriage and the follower of a corresponding said secondary carriage.

14. The system of claim 13 in which:
said first and second release assemblies further comprise respective first and second release rail assemblies generally transversely oriented with respect to said system axis and extending respectively between said first and second pick-up regions and said first and second receiving positions;
said first and second rearward trolleys are movably supported upon two or more recovery trolley wheels rotationally supported by respective said first and second puller rail assemblies; and
further comprising first and second recovery trolley drive assemblies configured to drivably move respective said first and second recovery trolleys between said first and second pick-up regions and said first and second receiving positions;

15. The system of claim 14 in which:
said first and second release rail assemblies further comprise respective first and second recovery trolley cams extending respectively between said first and second pick-up regions and said first and second receiving positions; and
said first and second recovery trolleys are configured having respective first and second recovery trolley cam followers respectively guidably engageable with said first and second recovery trolley cams.

16. A mold for forming corrugated pipe from thermoplastic material, comprising:
a generally semi-cylindrically shaped mold body disposed about a mold set axis, said mold body having an internal mold cavity region configured with an outwardly depending sequence of mold crests spaced apart to define a sequence of inwardly depending vacuum support regions, said mold body having an outward surface with outwardly disposed annular standoff structures spaced apart to define cooling regions;
a sequence of annular insert components, one of each being positioned over a said inwardly depending vacuum support region to form a mold valley and define a vacuum cavity with vacuum openings positioned to draw said thermoplastic material into said mold valley; and
a cover plate assembly connected across said mold body standoff structures to define one or more fluid receiving cooling chambers.

17. The mold of claim 16 in which:
said insert components are configured with oppositely disposed width defining edges; and
said vacuum openings are formed within one or both of said edges.

18. The mold of claim 17 in which:
said vacuum openings are configured as notches defining slit-shaped openings with the surface of an adjacent said mold crest.

19. The mold of claim 16 in which:
each said insert component is connected over a said vacuum support region by a plurality of screws extending through said mold body and said vacuum support region from an oppositely disposed said cooling region.

20. The mold of claim 16 further comprising:
a mold vacuum manifold located at said mold body outward surface and configured as a sequence of spaced apart vacuum passages each engageable in vacuum communication between a said vacuum cavity and a vacuum source.

21. The mold of claim 20 in which:
said vacuum passages are configured as a linear sequence of bores arranged normally to said mold set axis.

22. The mold of claim 16 in which:
said generally semi-cylindrically shaped mold body extends along said mold set axis between oppositely disposed generally flat mold side surfaces, and extends about said mold set axis between oppositely disposed generally flat mold mating surfaces;
a said generally flat mold side surface being configured with a seal retaining groove substantially extending between said mold mating surfaces; and
one or more said generally flat mating surfaces being configured with a seal retaining groove substantially extending between said oppositely disposed mold side surfaces.

23. The mold of claim 16 in which:
said generally semi-cylindrically shaped mold body extends about said mold set axis between oppositely disposed mold mating surfaces;
each said annular standoff structure comprises two portions each generally extending from the vicinity of a said mold mating surface to an air diversion portion;
said fluid is air; and
said cover plate assembly comprises two cover plate components each coupled to said standoff structures and configured to provide an air outlet in the vicinity of a said mold mating surface and extending to define an air inlet adjacent said air diversion portion.

24. The mold of claim 16 in which:
said generally semi-cylindrically shaped mold body extends about said mold set axis between oppositely disposed mold mating surfaces; and
further comprising a carriage assembly connected in supporting relationship with said mold body outward surface in the vicinity of a said mold mating surface and having a first locus of travel generally parallel with said mold set axis and a second locus of travel transverse to said mold set axis.

25. The mold of claim 16 in which:
said generally semi-cylindrically shaped mold body extends along said mold set axis between oppositely disposed mold side surfaces;
said mold body sequence of spaced apart mold crests extend from the vicinity of one said mold side surface to the commencement of a bell cavity extending, in turn, to the vicinity of a said mold side surface opposite said one side surface;
said mold body outward surface is configured having one or more outwardly depending wall pairs defining vacuum support regions;
one or more bell vacuum cover components each being positioned within a said outwardly depending wall pair of said vacuum support regions to define an outward vacuum cavity;
a bell mold insert component having a bell defining mold profile positioned within said bell cavity and connected to said mold body internal mold cavity region and having one or more vacuum openings communicating with a said outward vacuum cavity positioned to draw said thermoplastic material toward said bell defining mold profile.

26. The mold of claim 25 in which:
each said cover extends along said mold set axis between oppositely disposed edge surfaces located adjacent said wall pairs and each being configured to retain a sealing gasket in sealing contact with a wall of said wall pair.

27. The mold of claim 25 further comprising:
a mold vacuum manifold located at said mold body outward surface and configured as a sequence of spaced apart vacuum passages each engageable in vacuum communication between a said outward vacuum cavity and a source of vacuum.

28. A system for providing corrugated pipe by maneuvering paired molds about a die assembly generally disposed about a system axis, comprising:
a plurality of paired molds, each mold having a generally semi-cylindrically configured corrugate mold profile and dynamically connectable with a vacuum source and a cooling fluid, each said mold being supported upon a carriage assembly having a rail mountable primary carriage with a first locus of travel generally parallel with said axis and a secondary carriage with a second locus of travel generally transverse to said axis extending between mold defining and release orientations and each said carriage assembly having a connector assembly drivable to move said mold in a direction generally parallel with said axis;
first and second feed assemblies extending generally transversely to said system axis from respective first and second acquisition positions to a paired mold receiving region generally aligned with said system axis, each said first and second feed assembly being configured to acquire a mold of a mold pair at a respective said first and second acquisition position and move it into paired relationship establishing a said mold pair at said receiving region;
a translation assembly generally extending in parallel with said axis drivably engageable with the connector assemblies of the said primary carriages of a mold pair at a reference region to establish a forming tunnel region as a sequence of mutually adjacently disposed paired molds moving in driven relationship with said translation assembly along said primary carriage first locus of travel;
a mold positioning assembly generally located at said receiving region and configured to move a mold pair positioned thereat into abutting adjacency with a said mold pair at said reference region;
first and second release assemblies respectively drivably engageable with one mold of a said mold pair subsequent to movement of said mold pair through said forming tunnel region and configured to drive the secondary carriage of each said mold along said second locus of travel into said release orientation and move said molds to respective first and second receiving positions; and
first and second mold return assemblies each spaced outwardly from said axis and configured to receive one mold of each mold pair at a respective said first and second receiving position and to drivably move the primary carriage of each said received mold to respective first and second queue regions having respective first and second forwardmost feed positions adjacent respective said first and second acquisition positions and further configured to move each mold of a mold pair having a mold at said first and second forwardmost feed positions into respective said first and second acquisition positions.

29. The system of claim 28 in which:
said first and second return assemblies are configured to maneuver the said secondary carriages along said second locus of travel into said mold defining orientation.

30. The system of claim 28 in which:
said mold positioning assembly comprises first and second pusher assemblies each configured to move a respective mold of a mold pair synchronously into said abutting adjacency with a mold pair at said reference region.

31. The system of claim 28 in which:
said first and second return assemblies are each configured with first and second spaced apart return rails extending from respective said first and second receiving positions to respective said first and second forwardmost feed positions, said first and second return rails being configured to movably support a said primary carriage, and further comprising respective first and second rail conveyor assemblies engageable with a said primary carriage at a respective said first and second receiving position and configured to move a said engaged primary carriage into a respective said first and second queue region.

32. The system of claim 31 in which:
said first and second rail conveyor assemblies are further configured to engage a primary carriage located at respective said first and second forwardmost feed positions and move it into respective said first and second acquisition positions.

33. The system of claim 31 in which:
said first and second rail conveyor assemblies are configured to engage and move three adjacent said primary carriages including primary carriages at said first and second forwardmost feed positions at respective said first and second queue regions.

34. The system of claim 33 in which:
first and second rail conveyor assemblies are configured to engage said three adjacent primary carriages in a manner mutually spacing them apart a queue distance.

35. The system of claim 34 in which:
said queue distance is about one inch.

36. The system of claim 31 in which:
said first and second return assemblies further comprise respective first and second arrays of parking assemblies configured to engage and hold stationary those primary carriages located at respective first and second queue regions when not engaged with a respective said first and second rail conveyor assembly.

37. The system of claim 28 in which:
each said primary carriage is configured having two or more wheels effective to transport said carriage assembly along said first locus of travel; and
each said secondary carriage is mounted for movement upon a said primary carriage along said second locus of travel in driven relationship with a follower extending therefrom.

38. The system of claim 37 in which:
said first and second return assemblies are each configured with first and second spaced apart return rails extending from respective said first and second receiving positions to respective said first and second forwardmost feed positions and configured to movably support said primary carriage two or more wheels.

39. The system of claim 38 in which:
said first and second return assemblies further comprise respective first and second return transition cam tracks having entrances at respective said first and second receiving positions and extending mutually diagonally inwardly toward said axis to respective first and second return transition exits and configured to receive a said secondary carriage follower in drive relationship to effect movement of a secondary carriage from said release orientation toward said mold defining orientation.

40. The system of claim 39 in which:
said first and second return assemblies further comprise respective first and second return cam tracks generally in parallel with said system axis extending from respective said first and second transition exits to respective said first and second forwardmost feed positions and configured to receive a said secondary carriage follower to effect retention of a corresponding said secondary carriage in said mold defining orientation.

41. The system of claim 40 in which:
said first and second feed assemblies comprise respective first and second feed trolleys drivably moveable between respective said first and second acquisition positions and said paired mold receiving region, each said first and second feed trolley being configured to receive a said primary carriage and the follower of a corresponding said secondary carriage.

42. The system of claim 41 in which:
said first and second feed assemblies further comprise respective first and second feed rail assemblies generally transversely oriented with respect to said system axis and extending respectively between said first and second acquisition regions and said paired mold receiving region;
said first and second feed trolleys are movably supported upon two or more feed trolley wheels rotationally supported by respective said first and second feed rail assemblies; and
further comprising first and second feed trolley drive assemblies configured to drivably move respective said first and second feed trolleys between said first and second acquisition regions and said paired mold receiving region.

43. The system of claim 42 in which:
said first and second feed assemblies further comprise respective first and second feed trolley cams extending respectively between said first and second acquisition regions and said receiving region; and
said first and second feed trolleys are configured having respective first and second feed trolley cam followers respectively guidably engageable with said first and second feed trolley cams.
